(19) United States
(12) Patent Application Publication
(10) Pub. No.: US 2025/0372928 A1
(43) Pub. Date: Dec. 4, 2025

(54) SINGLE POLE SPLICING CONNECTOR

(71) Applicant: IDEAL Industries, Inc., Sycamore, IL (US)

(72) Inventors: Jason W. Ludewig, Rockford, IL (US); Alan E. Zantout, Sycamore, IL (US); Douglas A. Sanford, Naperville, IL (US)

(21) Appl. No.: 19/222,506

(22) Filed: May 29, 2025

Related U.S. Application Data
(60) Provisional application No. 63/652,763, filed on May 29, 2024.

(51) Int. Cl. H01R 24/84; H01R 13/502

(52) U.S. Cl. CPC H01R 24/84; H01R 13/502

(57) ABSTRACT

An electrical connector are disclosed for facilitating electrical coupling between multiple electrical conductors and busbars. The connector includes a housing defining conductor ports and a housing port, a busbar positioned within the housing for electrically coupling conductors, and an extension tab accessible through the housing port for electrical contact with a secondary busbar of another connector. A connector system comprises a first connector and a second connector, each with respective housings, busbars, and extension tabs, enabling mutual electrical coupling when the extension tabs are inserted into corresponding housing ports. The connectors may be structurally identical and support various configurations of port orientations.

### CROSS-REFERENCE TO RELATED APPLICATIONS

The present disclosure claims priority to U.S. Provisional Application 63/652,763, titled “SINGLE POLE SPLICING CONNECTOR” and filed on May 29, 2024, which is incorporated herein by reference in its entirety.

### FIELD OF THE DISCLOSURE

The present description relates generally to electrical connectors and more particularly to a single pole splicing connector.

### BACKGROUND OF RELATED ART

Generally, splice connectors are used to connect the ends of two or more electrical conductors, such as wires. In some instance, the splice connectors can be twist-on or screw-on wire connectors. Splice connectors typically include a housing formed from an electrically insulating material, such as plastic, in which is disposed an electrical connecting element formed from an electrically conductive material, such as a shaped wire spring or other electrical terminal. The connecting element is used to bring the ends of the electrical conductors into secured electrical contact with each other to form an electrical connection.

In other instances, a multi-port connection terminal may be used to connect the ends of two or more electric conductors to form the electrical splice. Like the noted twist-on connectors, these multi-port connectors typically comprise a housing formed of an electrically insulating material, but rather than a single insertion hole, these connectors include multiple ports for insertion of multiple electrical conductors (typically one conductor in each port). An electrical connecting element is formed from an electrically conductive material and placed proximate to the port such that any electrical conductor inserted into the port is coupled to the connecting element. A common electrical bus is typically utilized to electrically couple each of the electrical connecting elements. Thus, by inserting and retaining the wires in the provided ports, all of the inserted wires are electrically coupled to one another.

### BRIEF DESCRIPTION OF THE DRAWINGS

FIG. 1 is a front perspective view of a first example in-line splicing connector in a 4-port configuration.

FIG. 2 is a rear perspective view of the example connector of FIG. 1.

FIG. 3 is a front view of the example connector of FIG. 1.

FIG. 4 is a rear view of the example connector of FIG. 1.

FIG. 5 is a top view of the example connector of FIG. 1.

FIG. 6 is a left-side view of the example connector of FIG. 1.

FIG. 7 is a right-side view of the example connector of FIG. 1.

FIG. 8 is a rear perspective exploded view of an example connector having the features of the connector of FIG. 1, but in a 2-port configuration.

FIG. 9 is a rear perspective view of an example connector system including two of the example connectors of FIG. 8 with a cross-section of the housings.

FIG. 10 is a rear perspective view of the internal components of the example connector system of FIG. 9.

FIG. 11 is a rear perspective exploded view of the internal components of the example connector of FIG. 8.

FIG. 12 is a front perspective view of the example connector of FIG. 1 receiving electrical conductors.

FIG. 13 is a front perspective view of the example connector of FIG. 8 joining the example connector of FIG. 1 to form the example connector system of FIG. 10.

FIG. 14 is a front perspective view of the example connector system of FIG. 13 receiving electrical conductors in one direction.

FIG. 15 is a front perspective view of the example connector system of FIG. 13 receiving electrical conductors in two directions.

FIG. 16 is a front perspective view of an example connector hub receiving the example connector of FIG. 1.

FIG. 17 is a front perspective view of the example connector hub of FIG. 16 including the example connector of FIG. 1.

FIG. 18 is a rear perspective view of an example connector hub receiving the example connector of FIG. 8.

FIG. 19 is a rear perspective view of the example connector hub of FIG. 18 including the example connector of FIG. 8.

FIGS. 20-27 is another embodiment the example connector of FIG. 8.

FIGS. 28-34 is another embodiment of the example connector system of FIG. 9.

FIG. 35 is a front perspective view of an example in-line splicing connector in a 3-port configuration.

FIG. 36 is a rear perspective view of the example connector of FIG. 35.

FIG. 37 is a front view of the example connector of FIG. 35.

FIG. 38 is a top view of the example connector of FIG. 35.

FIG. 39 is a right-side view of the example connector of FIG. 35.

FIG. 40 is a rear perspective exploded view of the example connector of FIG. 35.

FIG. 41 is a rear perspective exploded view of the internal components of the example connector of FIG. 35.

FIG. 42 is a rear perspective view of an example connector system including the example connector of FIG. 35 and an example connector in a 2-port configuration with a cross-section of the housings.

FIG. 43 is a rear perspective view of the internal components of the example connector system of FIG. 42.

FIG. 44 is a front perspective view of the example connector of FIG. 35 receiving electrical conductors.

FIG. 45 is a front perspective view of the example connector in a 2-port configuration joining the example connector of FIG. 35 to form the example connector system of FIG. 42.

FIG. 46 is a front perspective view of the example connector system of FIG. 42 receiving electrical conductors in one direction.

FIG. 47 is a rear perspective view of the example connector system of FIG. 42 receiving electrical conductors in two directions.

FIG. 48 is a front perspective view of an example in-line splicing connector in a 2-port configuration.

FIG. 49 is a rear perspective view of the example connector of FIG. 48.

FIG. 50 is a front view of the example connector of FIG. 48.

FIG. 51 is a rear view of the example connector of FIG. 48.

FIG. 52 is a side view of the example connector of FIG. 48.

FIG. 53 is a bottom view of the example connector of FIG. 48.

FIG. 54 is a rear perspective exploded view of the example connector of FIG. 48.

FIG. 55 is a rear perspective exploded view of the internal components of the example connector of FIG. 48.

FIG. 56 is a rear perspective view of an example connector system including the example connector of FIG. 48 and an example connector in a 4-port configuration with a cross-section of the housings.

FIG. 57 is a rear perspective view of the internal components of the example connector system of FIG. 56.

FIG. 58 is a front perspective view of the example connector of FIG. 48 receiving electrical conductors.

FIG. 59 is a front perspective view of the example connector of FIG. 48 joining the example connector in a 4-port configuration to form the example connector system of FIG. 56.

FIG. 60 is a front perspective view of the example connector system of FIG. 56 receiving electrical conductors in one direction.

FIG. 61 is a front perspective view of the example connector system of FIG. 56 receiving electrical conductors in two directions.

FIG. 62 is a front perspective view of an example connector hub receiving the example connector of FIG. 48.

FIG. 63 is a front perspective view of the example connector hub of FIG. 62 including the example connector of FIG. 48.

FIG. 64 is a rear perspective view of an example connector hub receiving the example connector in a 4-port configuration of FIG. 56.

FIG. 65 is a rear perspective view of the example connector hub of FIG. 64 including the example connector in a 4-port configuration of FIG. 56.

FIGS. 66-72 is another embodiment the example connector of FIG. 48

FIGS. 73-79 is another embodiment of an example connector system including two of the example connectors of FIG. 66.

FIG. 80 is a rear perspective view of an example in-line splicing connector in a 3-port configuration.

FIG. 81 is a bottom front perspective view of the example connector of FIG. 80.

FIG. 82 is a front view of the example connector of FIG. 80.

FIG. 83 is a top view of the example connector of FIG. 80.

FIG. 84 is a side view of the example connector of FIG. 80.

FIG. 85 is a bottom view of the example connector of FIG. 80.

FIG. 86 is a rear perspective exploded view of the example connector of FIG. 80.

FIG. 87 is a rear perspective exploded view of the internal components of the example connector of FIG. 80.

FIG. 88 is a rear perspective view of an example connector system including the example connector of FIG. 80 and an example connector in a 4-port configuration with a cross-section of the housings.

FIG. 89 is a rear perspective view of the internal components of the example connector system of FIG. 88.

FIG. 90 is a front perspective view of the example connector of FIG. 80 receiving electrical conductors.

FIG. 91 is a front perspective view of the example connector in a 4-port configuration of FIG. 88 joining the example connector of FIG. 80 to form the example connector system of FIG. 88.

FIG. 92 is a front perspective view of the example connector system of FIG. 88 receiving electrical conductors in one direction.

FIGS. 93-99 is another embodiment of the example connector in a 2-port configuration.

FIGS. 99-102 is another embodiment of the example connector system including two of the example connectors of FIG. 93.

### DETAILED DESCRIPTION

The number of wires that may be spliced together with a splice connector is typically limited by the size of the splice connector. For example, the number of wires that may be spliced with the multi-port connection terminal is limited by the number of ports available in the connector itself. In other words, connectors with ports have a finite number of ports. Because of this, if a user's electrical termination needs change (e.g., more or fewer wires need to be connected), the connector oftentimes needs to be replaced with a new, larger or smaller connector. Such replacements result in wasted time, increased costs, and inefficiencies during installation or maintenance. Furthermore, existing connectors often require deenergizing the system to add or remove electrical conductors, which can be inconvenient and time-consuming, particularly in scenarios involving live power sources.

The present disclosure addresses these limitations by introducing a customizable splice connector that facilitates the addition or removal of auxiliary or accessory ports as needed. The customizable splice connector enables users to dynamically expand or contract the number of connection points without replacing the entire connector, thereby reducing waste and installation time. The customizable splice connector can function as a standalone unit or as part of an assembly of daisy-chained or otherwise interconnected connectors, offering flexibility in configuration. Additionally, the customizable splice connector can be “touch safe,” ensuring user safety even when handling live power sources. This feature allows electrical conductors to be added, removed, or rearranged while the system remains energized, eliminating the need for deenergization and minimizing interruptions.

A technical solution of the present disclosure involves a connector housing with at least two ports for receiving electrical conductors and an internal conductive element, such as a spring conductor, that secures and electrically couples the electrical conductors. The housing further includes auxiliary apertures (e.g., housing ports) exposing additional contacts (e.g., extension tabs) of the conductive element, which enable the connector to be operably coupled (e.g., electrically couplable) to additional electrical connectors or electrical devices. The modular design allows for various coupling arrangements, such as “top-to-top,” “side-to-side,” “bottom-to-bottom,” or combinations thereof (e.g., “top-to-bottom” or “side-to-top”), and supports mixing and matching of different connector types. The customizable splice connector's architecture ensures that the housing remains touch safe when uncoupled, while the biasing resilient contacts facilitate secure and reliable electrical connections during coupling.

The following description of example methods and apparatus is not intended to limit the scope of the description to the precise form or forms detailed herein. Instead, the following description is intended to be illustrative so that others may follow its teachings.

The presently disclosed examples include the ability to add, or remove, auxiliary or accessory ports to connectors with various wire ports. The examples provide the ability to add or remove a connection point which meets electrical requirements in any configuration while also minimizing connector size to meet the user sizing requirements. To achieve these goals, the example splicing connectors can function as an individual connector or as an assembly of two or more connected connectors.

The examples disclosed may be utilized in any suitable connector type, including for instance in push-in connectors, lever connectors, insulation-displacement connector (IDC), insulation-piercing connector (IPC), and/or any other ported connector technologies. In addition, in at least one example, the connector may be “pluggable” into a device such as light switch, outlet receptacle, light fixture, and/or any other suitable electrical devices, including those that are hardwired.

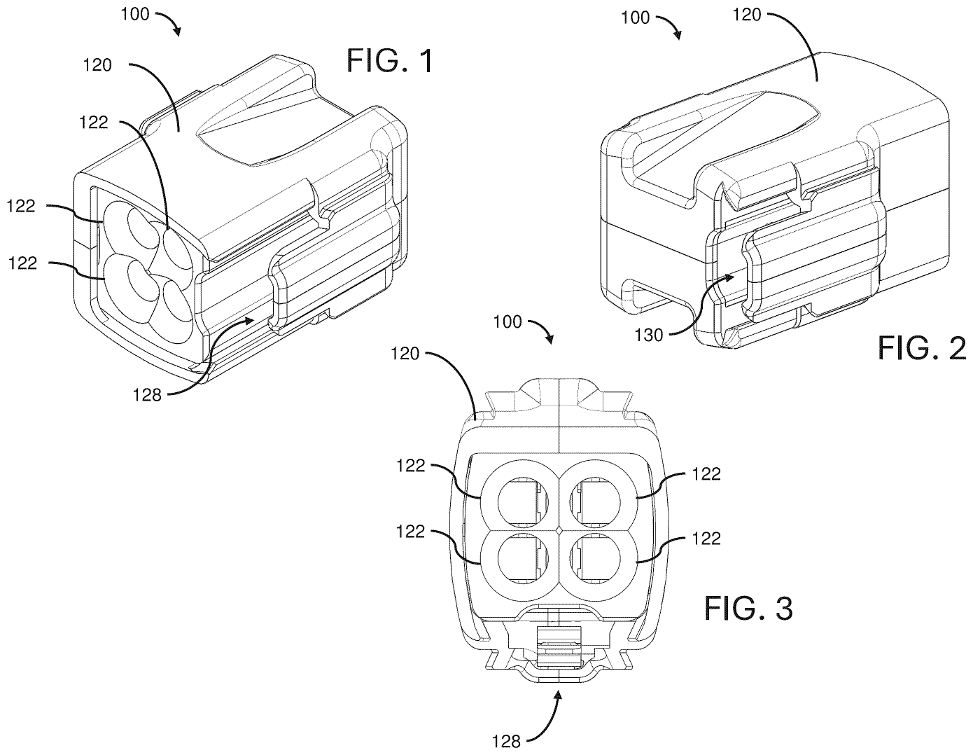

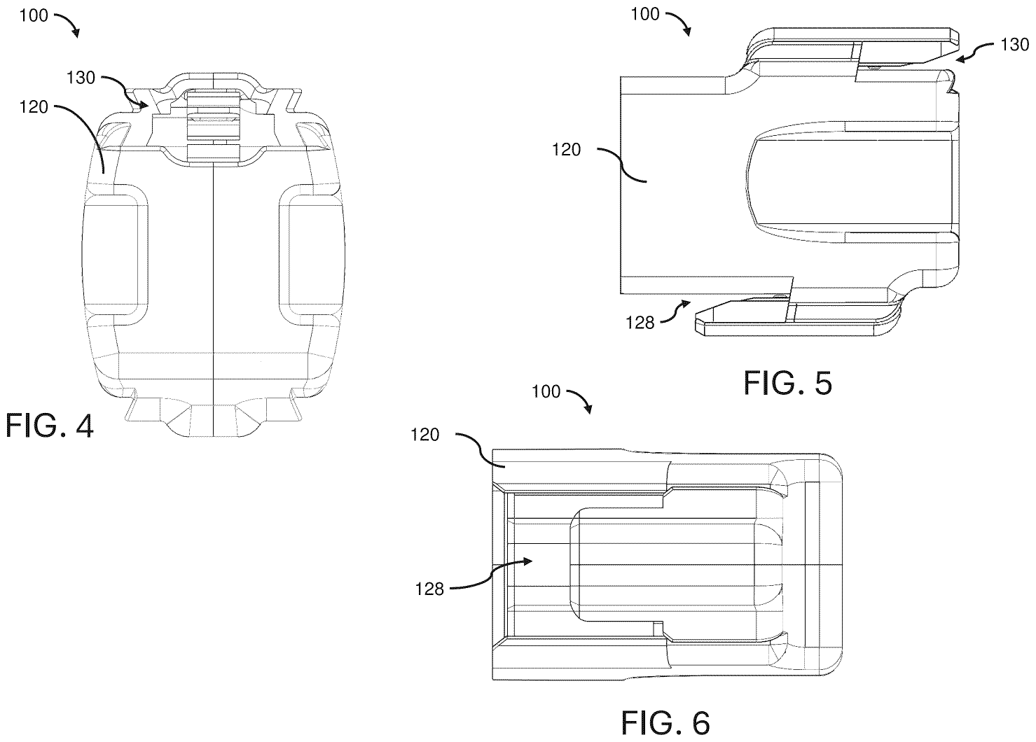

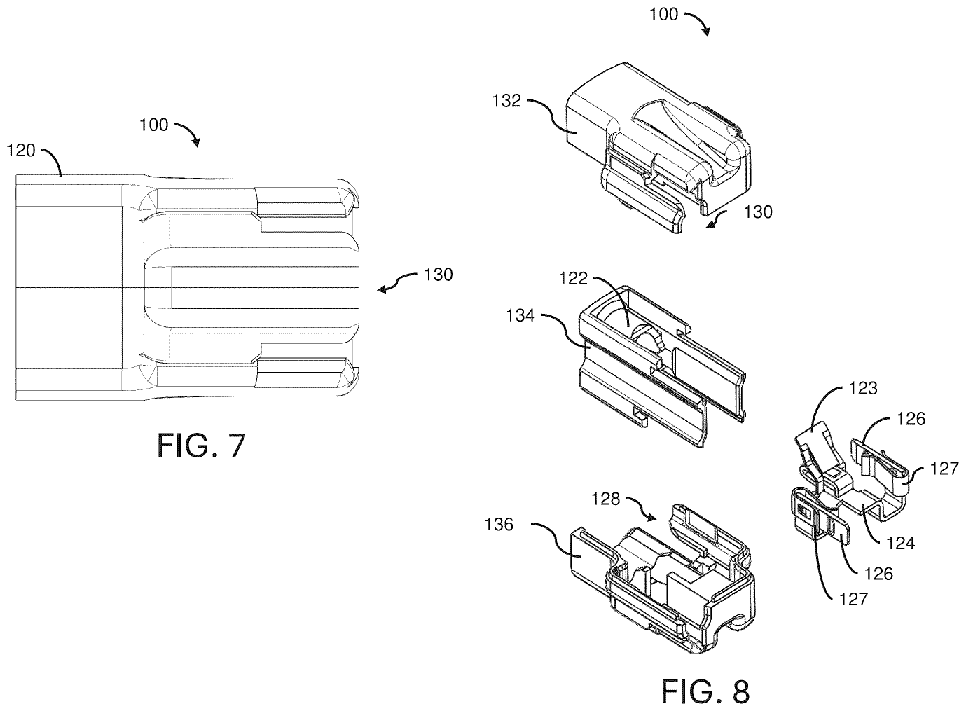

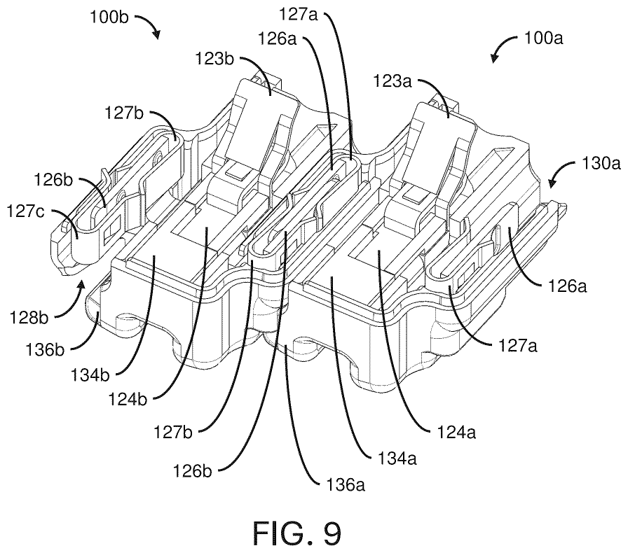

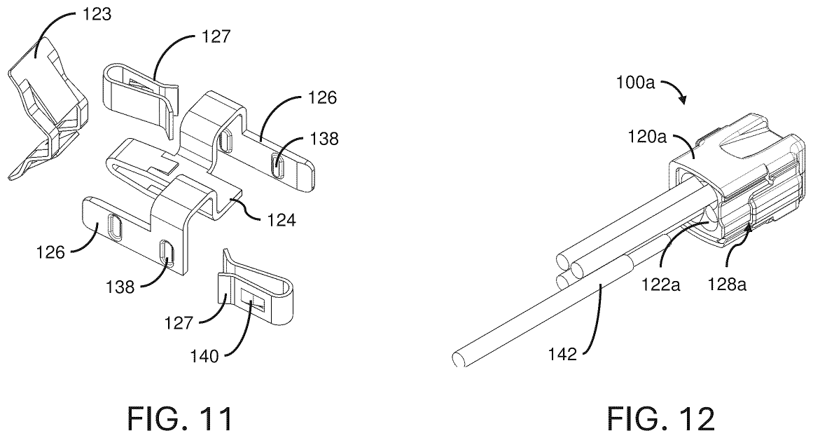

Referring now to the figures, FIGS. 1-12 are various views of an example splicing connector 100. For purposes of explanation, the connector 100 refers to the example splicing connector generally, while a particular implementation of the example connector in a 4-port configuration is referred to as a connector 100a (shown in FIG. 9) and the example connector in a 2-port configuration is referred to as a connector 100b (shown in FIG. 9). It should be understood that the connector 100 (like all connectors of this disclosure) is not limited to 4- and 2-port implementations and can include any number of ports.

The connector 100 includes a housing 120 (e.g., housing 120a, 120b) with one or more conductor ports 122 (e.g., conductor ports 122a, 122b) and one or more housing ports 128, 130. Each of the conductor ports 122 may be configured to receive and retain one or more electrical conductors 142 in the housing 120. To retain the electrical conductors 142 (e.g., wire), each conductor port 122 may be associated with a connection type, such as a clamping connection or friction-based connection.

The clamping connection may include a push-in conductor connection mechanism 123 (e.g., conductor connection mechanism 123a, 123b), such as a spring or metal clip, positioned within the housing 120. The conductor connection mechanism 123 may exert a biasing force against the inserted electrical conductor 142 so that the electrical conductor 142 remains securely in place in a conductor port 122. When an electrical conductor 142 is inserted into the conductor port 122, the push-in conductor connection mechanism 123 may automatically engage, applying pressure to the electrical conductor 142 and holding it firmly against a busbar 124. This pressure provides mechanical retention and electrical contact, allowing current to flow between the electrical conductor 142 and the busbar 124.

In some embodiments, the clamping connection is a biasing mechanism where the connection mechanism 123 includes, e.g., a resilient metal spring made of materials, such as stainless steel or copper alloy. The spring may be preloaded to exert a constant force, and the shape of the spring may accommodate various wire gauges. When an electrical conductor 142 is inserted into a conductor port 122, the spring flexes slightly to allow the electrical conductor 142 to pass through, then moves back into place to grip the electrical conductor 142. The spring's biasing force keeps the electrical conductor 142 in contact with the busbar 124.

In some embodiments, the clamping connection is a wedge or clip-based clamping connection where the connection mechanism 123 includes a metal wedge or clip that is positioned at an angle within the conductor port 122 and may be actuated by a lever. When an electrical conductor 142 is inserted into a conductor port 122, the electrical conductor 142 pushes the wedge or clip upward or sideways, creating a tight fit between the electrical conductor 142 and the busbar 124. The angled geometry of the wedge holds the wire securely, preventing accidental disconnection.

In some embodiments, the clamping connection is an insulation-displacement clamping connection (IDC) where the connection mechanism 123 includes a sharp, conductive blade or fork that pierces the insulation of the electrical conductor 142 as the electrical conductor 142 is pushed into the conductor port 122. Once the insulation is pierced, the blade makes direct contact with the electrical conductor 142, establishing both mechanical retention and electrical connectivity.

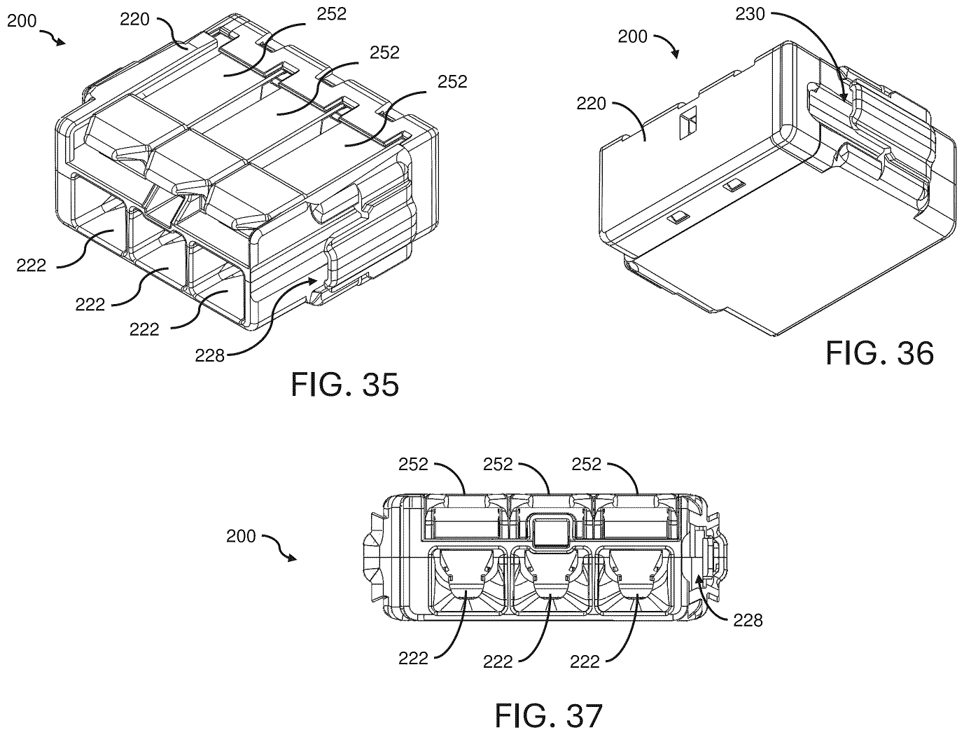

In some embodiments, clamping connections may also include additional features to enhance their functionality. For example, a clamping connection may include a release mechanism, such as a lever (shown in FIG. 35) or button. Clamping connections may also or instead include visual indicators, such as colored markings or transparent housings, to confirm proper wire insertion. Clamping connections may also be configured to accommodate multiple electrical conductors in a single conductor port 122, enabling parallel connections without the need for additional components.

Within the housing 120, the connector 100 also includes at least one busbar 124 that serves as a common conductive pathway that electrically couples the electrical conductors 142 that are inserted through or into the connector 100 and are in contact with the busbar 124. The busbar 124 may be made from a conductive material, such as copper, aluminum, or alloys thereof. The busbar 124 may have a flat, rectangular, cylindrical, or other appropriate profile, depending on the design of the connector 100 and current-carrying requirements.

In some embodiments, the busbar 124 is integrally (e.g., monolithically) formed with the connection mechanism 123 to electrically couple the multiple electrical conductors 142 inserted into the conductor ports 122.

The busbar 124 may include one or more extension tabs 126 that extend from the busbar 124 and extend into (or are otherwise accessible via) one or more of the housing ports 128, 130 of the connector 100. The extension tabs 126 may be electrically coupled to the busbar 124 for facilitating electrical contact with the busbar or extension tabs of another electrical connector. The extension tabs 126 may also be made from a conductive material, such as copper, aluminum, or alloys thereof, and may have a flat, rectangular, or cylindrical profile. In some embodiments, the extension tabs 126 may be monolithic with the busbar 124.

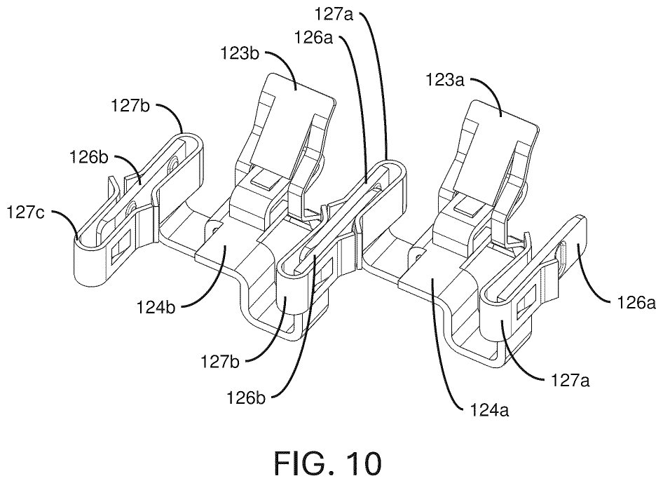

The extension tabs 126 may be accessible through their associated housing port 128, 130 so that they may come into electrical contact with the extension tabs of other connectors when joined together. For example, FIGS. 9-10 show the extension tab 126a in electrical contact with secondary extension tab 126b facilitating the electrical connection between the busbar 124a and secondary busbar 124b when connector 100a is joined with connector 100b. In some embodiments, the busbar 124a is parallel with the extension tab 126a and/or secondary busbar 124b. For example, a plane of the busbar 124a may be parallel with a plane of the extension tab 126a and/or a plane of the secondary busbar 124b. In some embodiments, the busbar 124a is perpendicular to the secondary busbar 124b. For example, a plane of the busbar 124a may be perpendicular with a plane of the extension tab 126a and/or a plane of the secondary busbar 124b.

Each of the housing ports 128, 130 may be configured to receive and retain one or more connectors in the housing 120. Housing ports 128, 130 may be specialized apertures or openings in the housing 120 of the connector 100 that facilitate the physical and electrical coupling of two separate connectors. The housing ports 128, 130 enabling multiple connectors 100 to merge of their respective splicing configurations (e.g., busbars and extension tabs). Housing ports 128, 130 may enable touch-safe operation, keeping live components within the connectors 100 inaccessible to users during coupling or uncoupling connectors. Housing ports 128, 130 may be positioned on the housing 120 for compatibility with corresponding features, such as extension tabs or mating structures, of another connector. In some embodiments, the other connector may be structurally identical to the connector 100.

One or more of the housing ports 128, 130 may be configured as hermaphroditic connections enabling dovetailing between connectors. Additionally or alternatively, one or more of the housing ports 128, 130 may be female (e.g., housing port 128) and/or male (e.g., housing port 130) interfaces. Female housing ports 128 may include recessed openings that receive and retain a protruding male housing port 130, such as an extension tab or a mating structure, from another connector. One or more of the housing ports 128, 130 may include features such as snap-fit mechanisms, screws, latches, welds, and/or any other suitable mechanisms to couple the housing ports of two connectors. For example, a latch may be provided on an exterior surface of the housing 120 that, when opened, permits the coupling and uncoupling of the connector 100 with another connector via a housing port 128, 130 and extension tab or other mating structure. When closed, the latch may prevent removal of a coupled connector or prevent coupling of another connector. For example, the latch may be hingedly coupled with the housing.

In some embodiments, unlike the conductor ports 122, the housing ports 128, 130 may not provide access for an inserted conductor to be secured within the connector 100, e.g., a conductor inserted through a housing port 128, 130 may not easily reach a clamping connection.

Like the connection mechanism 123 for retaining an electrical conductor 142, the housing ports 128, 130 may include a connection mechanism 127 (e.g., connection mechanism 127a, 127b, 127c) for retaining an extension tab and/or housing of another connector. The connection mechanism 127 may include friction-based or snap-fit mechanisms, such as resilient clips, latches, or biasing mechanisms (e.g., springs), to enhance the mechanical retention and ensure a tight coupling. For example, as shown in FIG. 10, the connection mechanism 127 may be included for each extension tab 126 and may include a spring 140 that engages with a detent 138 of its extension tab 126 and/or the extension tab of another connector.

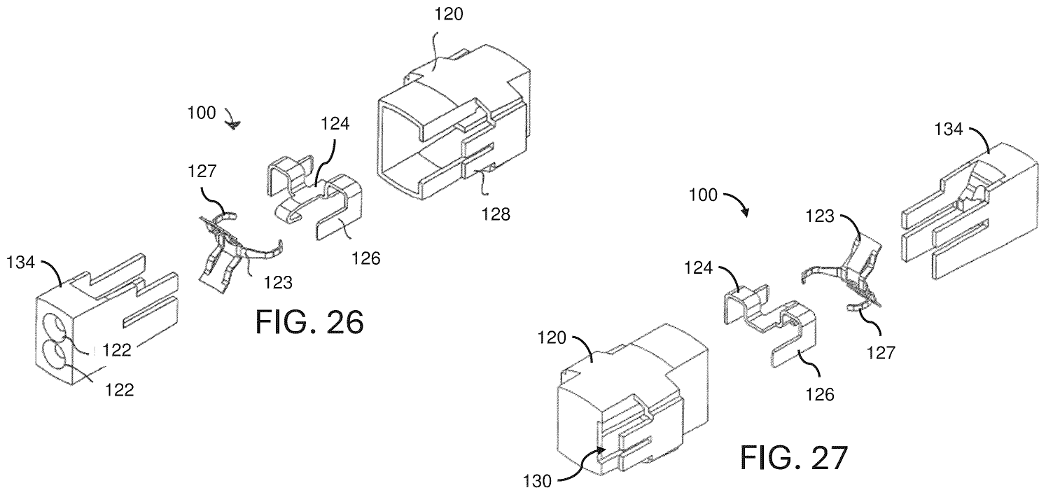

In some embodiments, the connection mechanism 127 may be monolithic with the connection mechanism 123. Particularly, the biasing mechanism of the connection mechanism 127 may be monolithic with the biasing mechanism of the connection mechanism 123 (e.g., shown in FIG. 26).

In some embodiments, the connection mechanism 127 may help retain the housing and/or an extension tab of another connector.

The housing 120 of the connector 100 may include an upper case 132, a lower case 136, and a cap 134 positioned between the upper case 132 and lower case 136. The upper case 132 and lower case 136 are the outermost components of the housing 120 and may be made from durable, electrically insulating materials such as molded plastic or polymer composites. The upper case 132 and lower case 136 (e.g., lower case 136a, 136b) may at least partially enclose and protect the internal components (e.g., connection mechanism 123, busbar 124, extension tab 126) of the connector 100. The upper case 132 and/or lower case 136 may individually or in combination define one or more of the housing ports 128, 130. The housing ports 128, 130 may be formed as an aperture, recess, protrusion, and/or any other suitable opening for receiving part of the housing of another connector.

The upper case 132 and/or lower case 136 may also include additional features, such as snap-fit mechanisms, screws, latches, welds, and/or any other suitable mechanisms to securely hold the upper case 132 and lower case 136 together to form the housing 120. The upper case 132 and/or lower case 136 may be ergonomically shaped to facilitate handling and installation, with smooth contours or textured surfaces for improved grip.

The cap 134 (e.g., cap 134a, 134b) is a component positioned between the upper case 132 and lower case 136, serving as the interface for insertion of the electrical conductor 142. The cap 134 defines the one or more conductor ports 122 through which electrical conductors 142, such as wires, are inserted into the housing 120. The cap 134, upper case 132, and/or lower case 136 may individually or in combination define one or more of the conductor ports 122. The conductor ports 122 may be formed as an aperture, recess, protrusion, and/or any other suitable opening for receiving an electrical conductor 142.

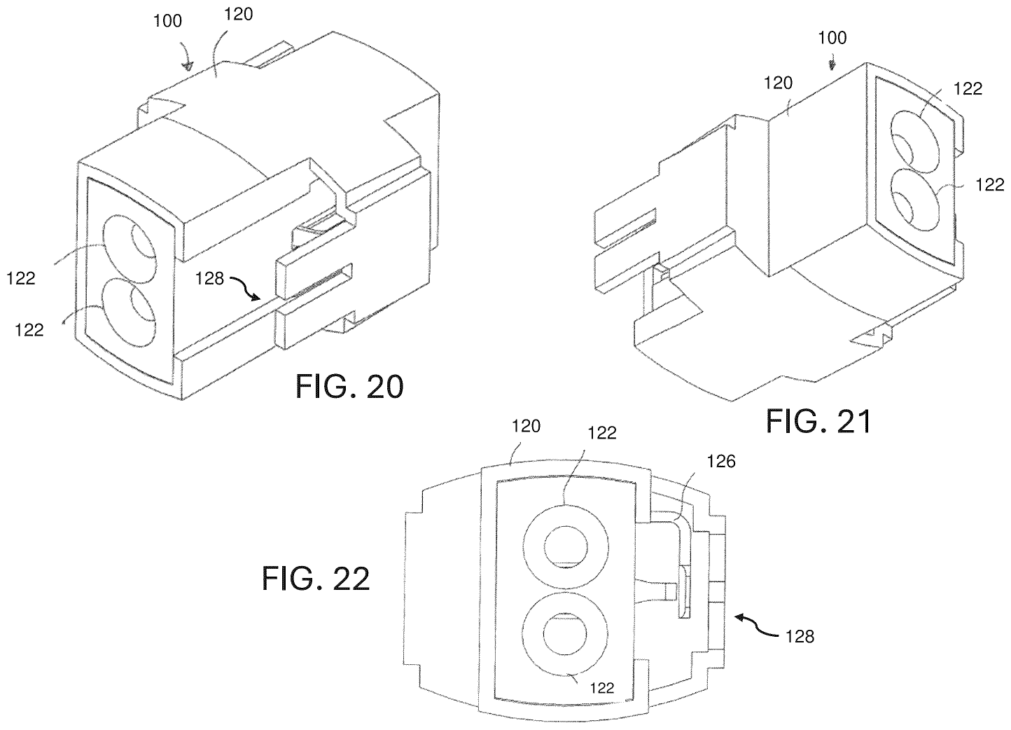

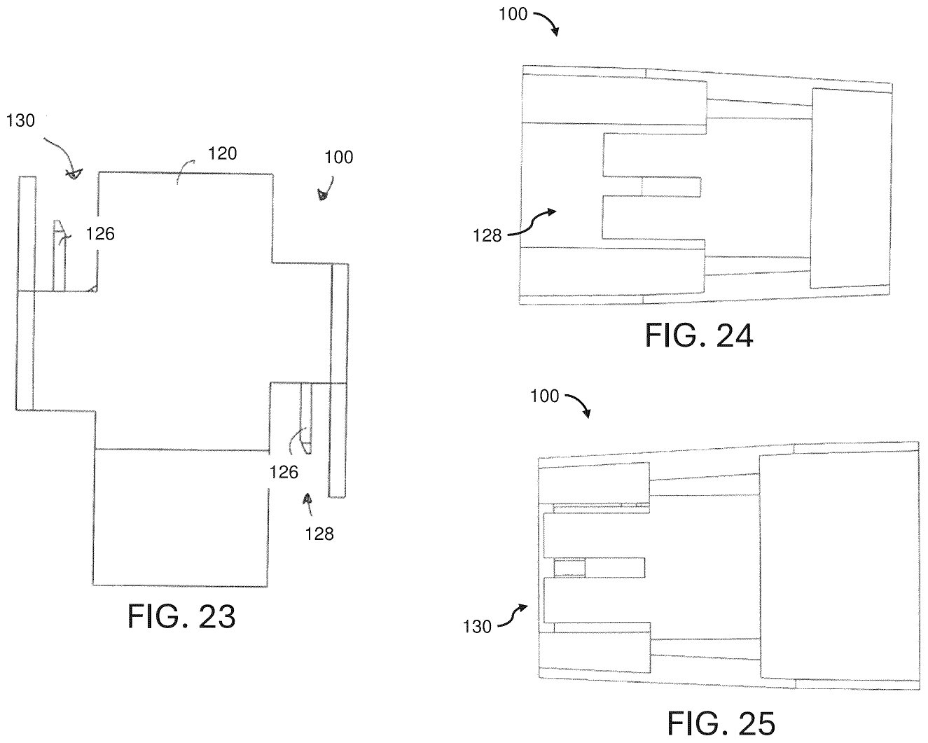

FIGS. 20-27 depicts another embodiment of the first example splicing connector of FIG. 1. The construction of this embodiment of the first example connector is similar to the first disclosed example, and the components are similarly arranged with various configuration differences.

FIGS. 12-15 depict a first example connector system. When two connectors 100 are joined via their housing ports 128, 130, the busbars 124 of each connector 100 are brought into electrical contact via their extension tabs 126, allowing the electrical conductors 142 spliced within each connector 100 to be electrically coupled. This forms an electrical connector system (shown in FIGS. 10-15) effectively expanding the splicing capacity of the connectors 100 and enabling users to dynamically add or remove connection points without replacing the entire connector assembly.

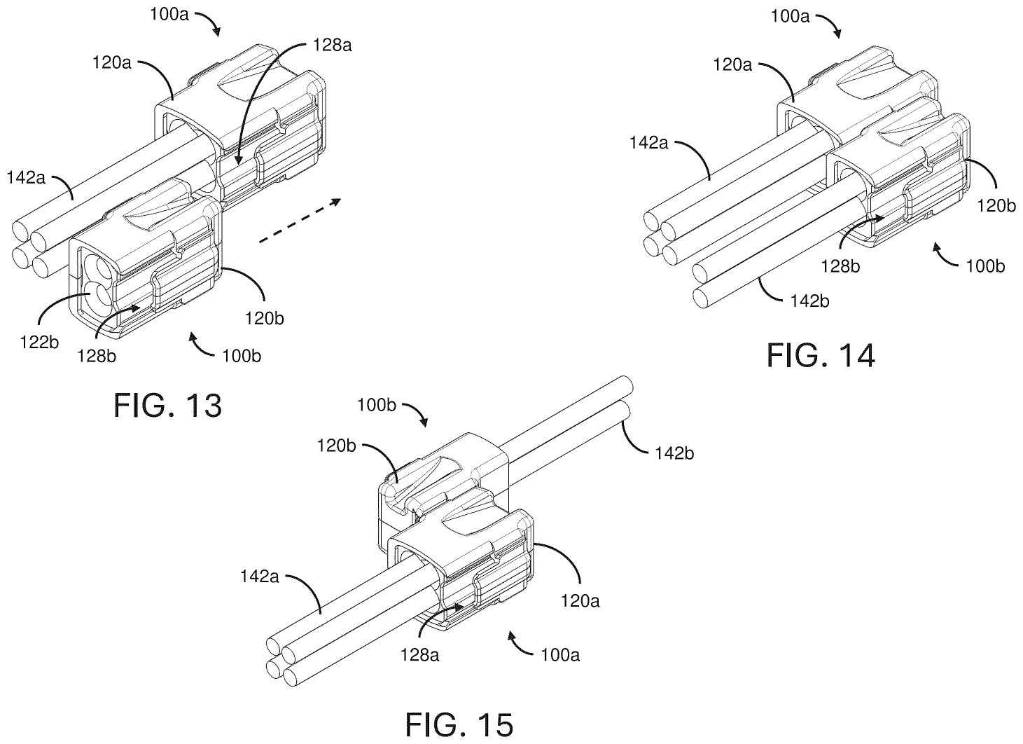

For example, as shown in FIG. 13, a connector 100a may include a housing port 128a that receives a secondary extension tab 126b of a secondary housing port 130b of a second connector 100b thereby placing the extension tab 126a in electrical contact with secondary extension tab 126b. The electrical contact of extension tabs 126a, 126b places the busbar 124a in electrical contact with the secondary busbar 124b as well as their electrical conductors 142a and the secondary electrical conductors 142b. The second connector 100b may include a secondary housing port 128b that can receive tertiary extension tab of a tertiary housing port of a third connector, continuing the chain of connectors.

Housing ports 128, 130 may be oriented in various configurations relative to each other on a connector 100, such as parallel, perpendicular, or offset, to accommodate different spatial arrangements and wiring requirements. For example, the orientation of the housing ports 128a, 130a in the connector 100a are parallel and facing opposite directions enabling the connector 100a to join a connector 100b in the same direction (as shown in FIG. 14) or opposing directions (as shown in FIG. 15). This flexibility allows connectors 100 to be joined in a variety of configurations, including a “top to top” configuration, a “bottom to bottom” configuration, a “top to side,” a “side to side,” and/or a “top to bottom” configuration.

Housing ports 128, 130 may be oriented in various configurations relative to the conductor ports 122 on a connector 100, such as parallel, perpendicular, or offset, to accommodate different spatial arrangements and wiring requirements. For example, the orientation of the housing ports 128, 130 are parallel with the orientation of the conductor ports 122 on connector 100 enabling the connector 100a, 100b, in FIG. 14, to receive electrical conductors 142 in a single direction (unidirectional) and, in FIG. 15, to receive electrical conductors 142 in opposing directions (bidirectional).

In some embodiments, the joining connector 100b may be a different type of connector that includes a similar mating arrangement to allow for “mixing and matching” of connector housings as desired. It will be appreciated that the construction of the connector 100a and the placement of the busbar 124a within the housing 120a of the connector 100a allows the connector 100a to be “touch safe” and prevents, to acceptable safety standards, user interaction with the busbar 124. As such, if the connector 100a is not coupled to another connector, such as the connector 100b, the connector 100a will act like a traditional terminal connector. However, as illustrated (e.g., in FIGS. 14-15), once the connector 100a and the second connector 100b are coupled, any secondary electrical conductors 142b provided in the secondary conductor ports 122b of the second connector 100b will be electrically coupled to the electrical conductors 142a provided in the conductor ports 122a of the connector 100a.

It is understood, however, that the coupling of the connector 100a with the connector 100b is completely optional. In particular, either of the connector 100a or the connector 100b may each be connected to various electrical conductors 142 and kept separate from each other to provide a separate splice all with the same polarity. As noted, the connector 100a is touch safe, and thus, even when not coupled to the connector 100b, the connector 100a may act as a safe splice.

It is further understood that the connector 100a and the connector 100b may be coupled while one or more of the connectors 100a, 100b includes a “hot” power supply, i.e., at least one of the inserted electrical conductors 142a, 142b is coupled to a live power source. In this manner, multiple electrical conductors 142a, 142b may be actively spliced together without any need to deenergize the system, thereby saving a user time, while still meeting safety considerations. Because there is no need to remove any “hot” electrical conductors physically from the connector 100a and/or there is no need to “cut” any electrical conductor 142a to remove the connector 100a from the electrical conductor 142a, additional electrical conductors 142a can be added and/or removed from the connector system with little interruption of installation time. In other words, the connector 100a may be serviced, expanded, contracted, or otherwise rearranged while under load.

In addition, it will be seen from the present disclosure that the connectors 100a, 100b may be constructed with any suitable number of conductor ports 122 and contacts (e.g., busbars 124) within the same housing 120 structure, such that the number of total conductor ports 122 available to the user may be customized as needed or desired by joining additional connectors via the housing ports 128, 130.

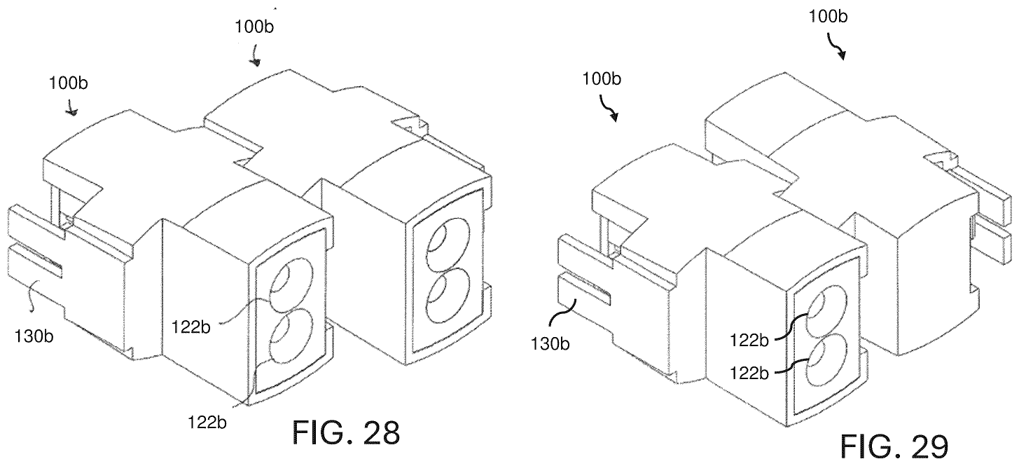

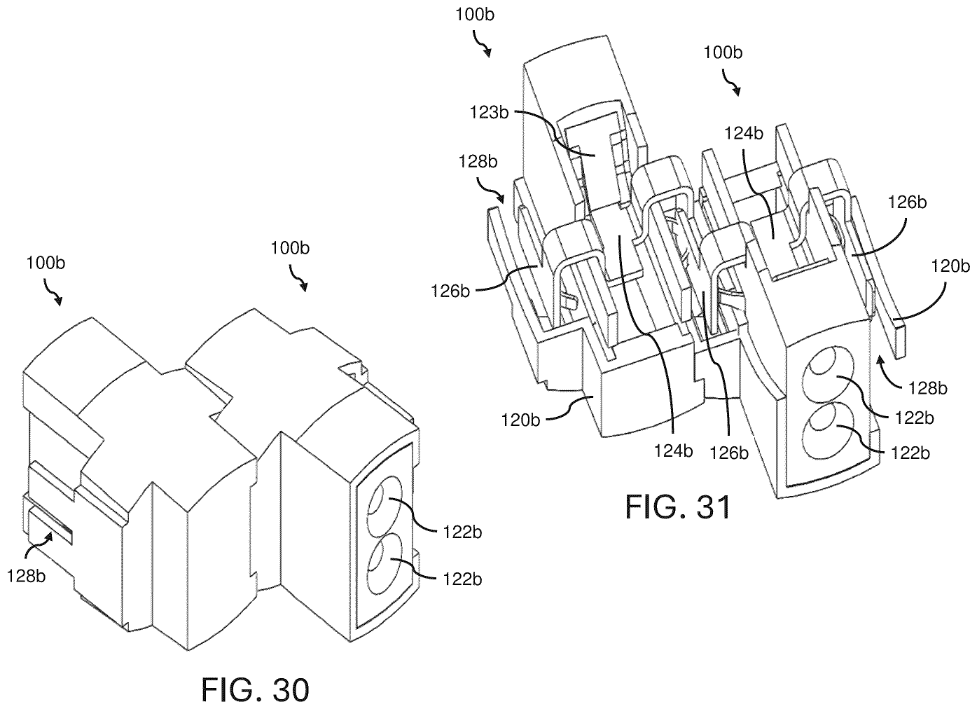

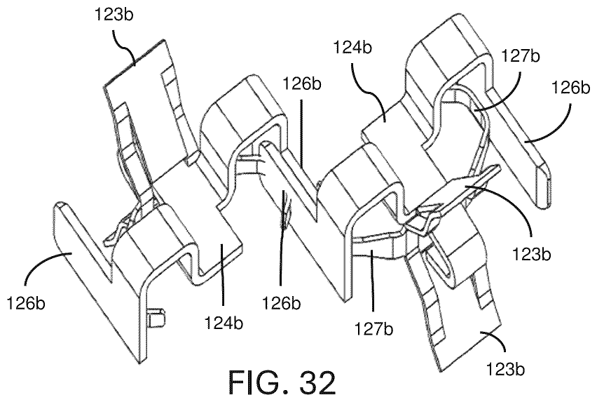

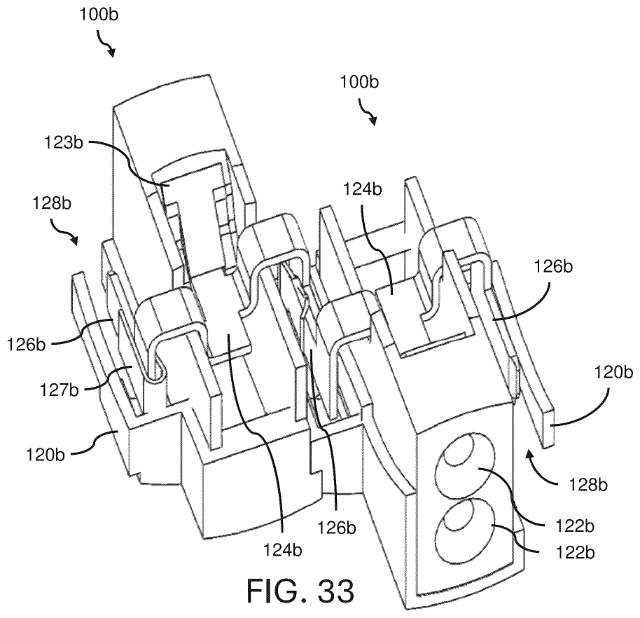

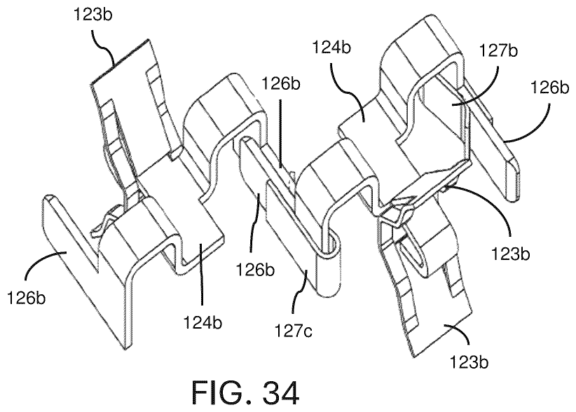

FIGS. 28-34 depict another embodiment of the first example connector system of FIG. 10. The construction of this embodiment of the first example connector system is similar to the first disclosed example, and the components are similarly arranged with various configuration differences. As shown in the figures, this embodiment may include the conductor connection mechanism 123 and connector connection mechanism 127 as part of a monolithic structure and the busbar 124 and extension tabs 126 as part of a monolithic structure.

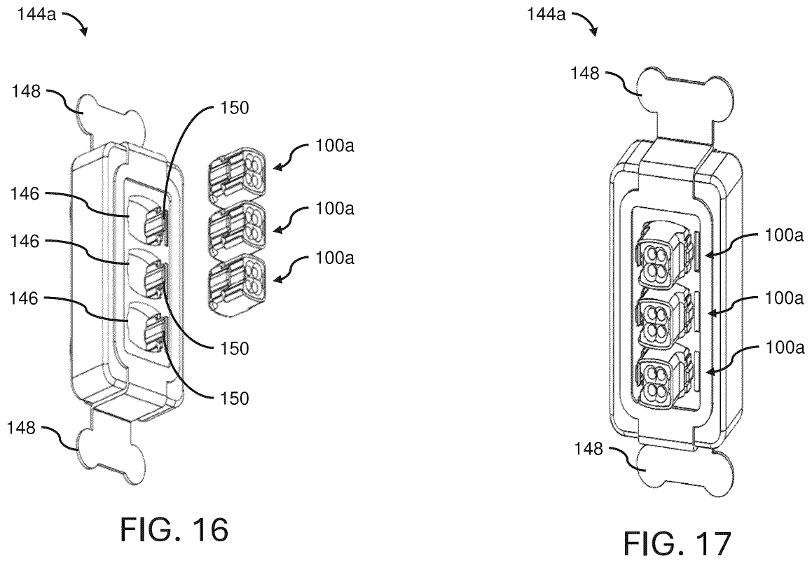

FIGS. 16-17 are various views of a first example of a connector hub 144a. A hub 144a may be a centralized interface that facilitates the coupling of multiple connectors 100. Unlike direct connector-to-connector coupling, the hub 144a provides a structured platform where individual connectors 100 can be inserted into designated connector ports 146, enabling electrical and mechanical integration of multiple connectors 100. In some embodiments, a hub may be an outlet, switch, dimmer, light fixture, or any other suitable device.

The hub 144a may include a housing with multiple connector ports 146, each configured to receive a connector 100. These connector ports 146 may include housing ports 150, similar to those found in individual connectors 100, and may include male or female interfaces to ensure compatibility with the connectors 100 being inserted. The housing ports 150 in the hub 144a may be arranged to accommodate various spatial configurations, such as linear, radial, or grid layouts. The hub 144a may be constructed from durable, electrically insulating materials, such as molded plastic or polymer composites, to provide mechanical support and touch-safe operation.

Each connector port 146 in the hub 144a may be equipped with internal conductive elements, such as busbars and/or extension tabs, that establish electrical contact with the connectors 100 inserted into the connector ports 146. These conductive elements may be interconnected inside and/or outside the hub 144a, creating a common electrical pathway that electrically couples all connected connectors 100 and their respective electrical conductors 142. These conductive elements enable the hub 144a to function as a centralized splicing unit, enabling the electrical conductors 142 within each connector 100 to be electrically coupled to one another without requiring direct connector-to-connector contact.

In some embodiments, the hub 144a is configured to be affixed to a surface, such as a wall, panel, or enclosure. The hub 144a housing may include brackets, flanges, holes, and/or any other suitable mounting mechanisms that are compatible with screws, bolts, and/or any other fasteners. The wall-mounted hub 144a provides a centralized location for managing electrical connections, reducing clutter and improving organization. By positioning the hub 144a on a surface like a wall, users can easily access the connector ports 146 for inserting or removing connectors 100 without interfering with other equipment or wiring.

In some embodiments, the hub 144a may include one or more terminals 148 (e.g., on its ends), enabling the hub 144a to interface with external systems or devices. These terminals 148 may include screw terminals, plug-in connectors, or other types of electrical interfaces that enable the hub 144a to be connected to power sources, circuit breakers, or additional hubs. The terminals 148 may be positioned at one or both ends of the hub 144a. The terminals 148 on the hub 144a may be electrically coupled to the internal conductive pathways, providing current flow between the hub 144a and the external system. For example, a hub 144a with terminals 148 can be connected to a main power supply, distributing electrical current to all connectors 100 inserted into the connector ports 146 of the hub 144a. Alternatively, the terminals 148 can be used to link multiple connector hubs 144a together, creating a larger splicing network with increased capacity. In some embodiments, the terminals 148 may be used for mounting purposes in addition to or instead of electrical connectivity purposes.

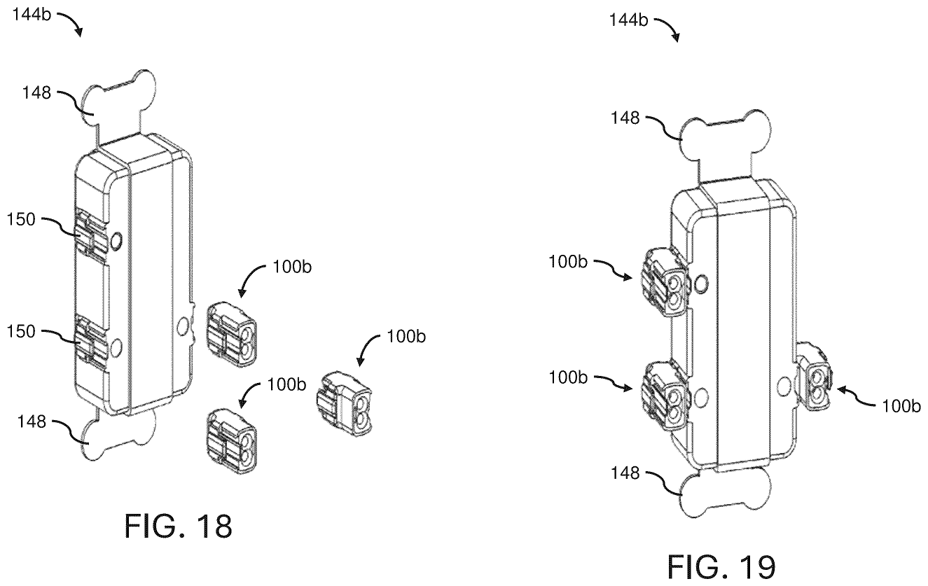

In some embodiments, as shown in FIGS. 18-19, the connector hub 144b also or instead includes housing ports 150 on the exterior of the connector hub 144b. Exterior housing ports 150 enables the connector hub 144b to accommodate differing sizes of connectors 100 as compatible connectors are not limited to the size of the connector ports 146.

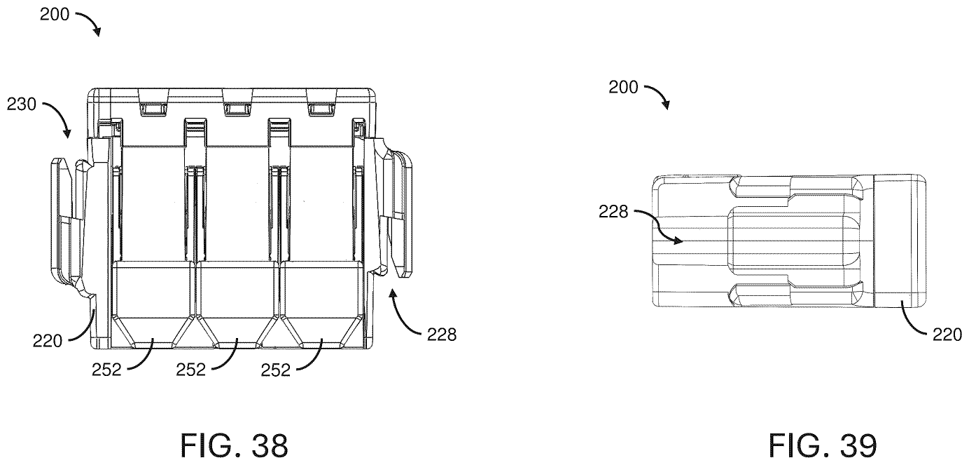

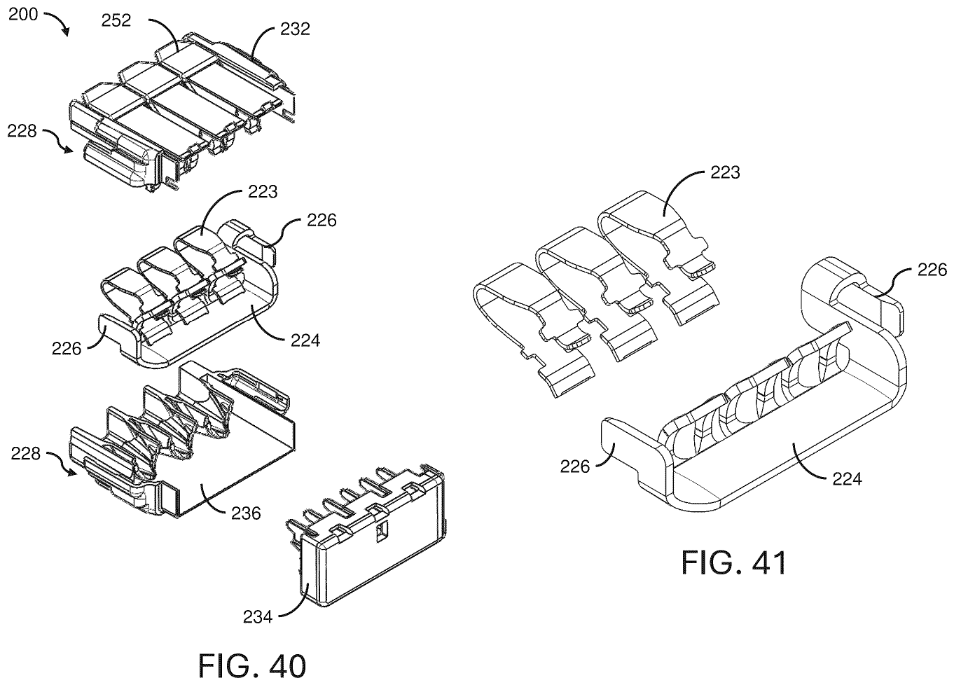

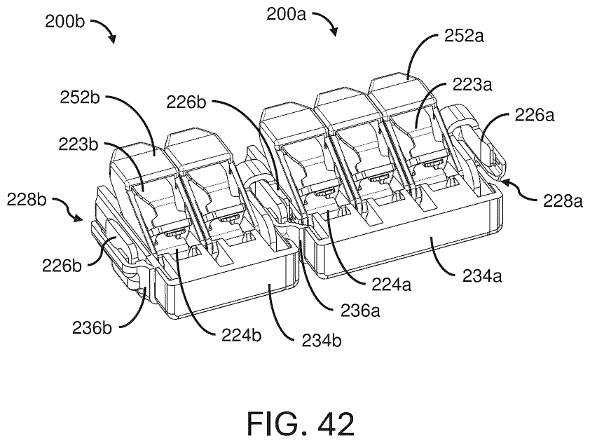

FIGS. 35-41 are various views of an example in-line splicing connector 200. For purposes of explanation, the connector 200 refers to the example splicing connector generally, while a particular implementation of the example connector in a 3-port configuration is referred to as a connector 200a (e.g., shown in FIG. 42) and the example connector in a 2-port configuration is referred to as a connector 200b (e.g., shown in FIG. 42). It should be understood that the connector 200 is not limited to 3- and 2-port implementations and can include any number of ports.

The splicing connector 200 is similar to the splicing connector 100 in terms of its overall structure, functionality, and purpose. The connector 200 includes a housing 220 (e.g., housing 220a, 220b) that defines multiple conductor ports 222 (e.g., conductor ports 222a, 222b) for receiving electrical conductors 242 (e.g., electrical conductors 242a, 242b), a busbar 224 (e.g., busbar 224a, 224b) positioned within the housing 220 to electrically couple the electrical conductors 242, and extension tabs 226 (e.g., extension tabs 226a, 226b) accessible through housing ports 228, 230 (e.g., housing ports 228a, 228b) to facilitate electrical contact with other connectors inserted therein. The housing 220 may include an upper case 232, lower case 236 (e.g., lower case 236a, 236b), and/or cap 234 (e.g., cap 234a, 234b) within the upper case 232 and lower case 236 and defining the conductor ports 222.

The busbar 224 may include or be electrically coupled to one or more extension tabs 226. A conductor connection mechanism 223 (e.g., conductor connection mechanism 223a, 223b) may include a spring or other biasing mechanism for holding an electrical conductor 242 against the busbar 224.

A distinction between the splicing connector 200 and the splicing connector 100 includes the connection mechanism associated with each conductor port 222. While the splicing connector 100 utilizes a push-in conductor connection mechanism 123, such as a spring or clip, to secure the electrical conductors, the splicing connector 200 incorporates lever connectors to secure the electrical conductors. One or more conductor ports 222 of the splicing connector 200 may be associated with a lever 252 (e.g., lever 252a, 252b) that can be manually actuated to open or close the conductor connection mechanism 223. This lever-based design provides enables users to insert or remove electrical conductors 242 without requiring significant force or specialized tools. The lever connectors may also provide a visual and/or tactile indication of whether the electrical conductor 242 is securely retained, improving reliability during installation and maintenance. The splicing connector 200 retains the modular and touch-safe features of the splicing connector 100, enabling it to be used individually or as part of an interconnected assembly of connectors (e.g., a connector system).

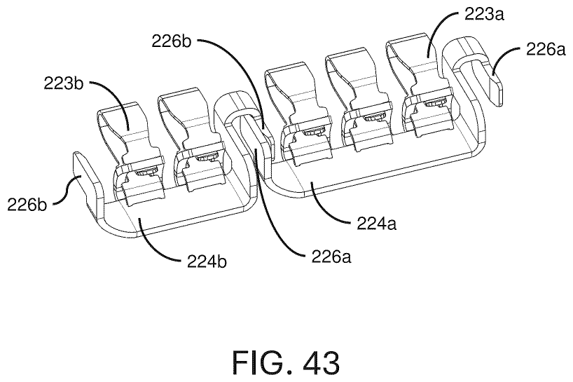

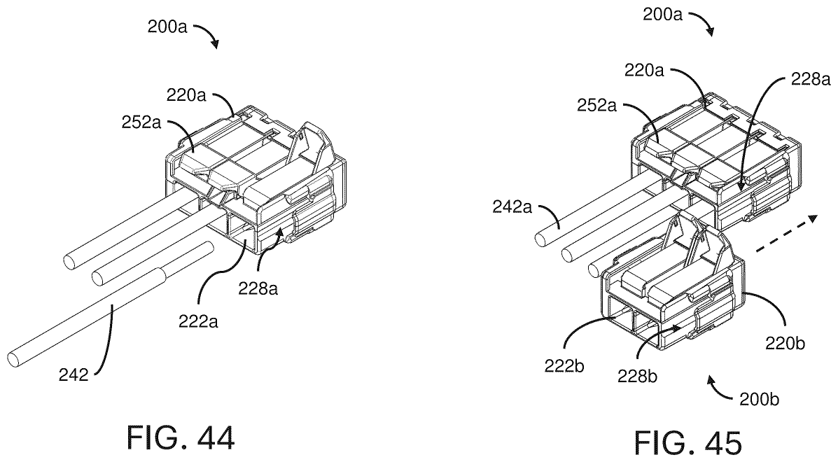

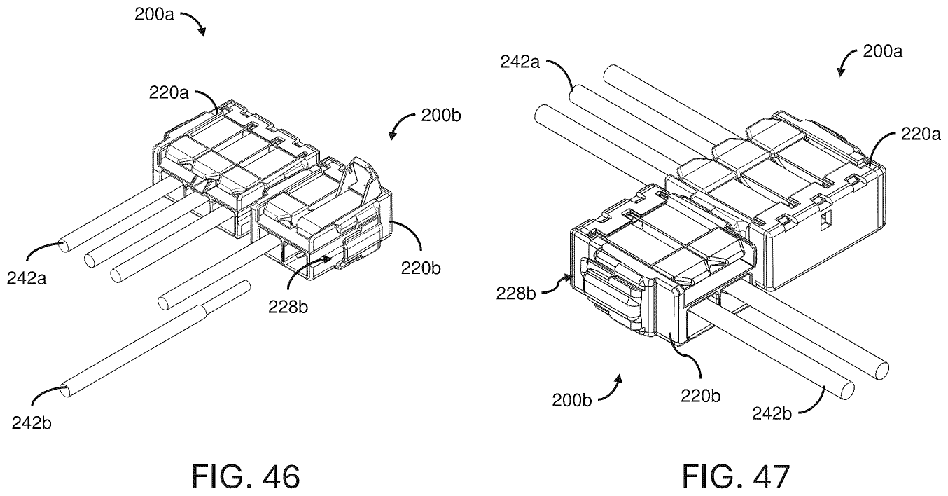

The connector system that utilizes splicing connectors 200, as illustrated in FIGS. 42-47, is similar to the connector system that utilizes splicing connectors 100, shown in FIGS. 10-15, in terms of its overall structure, functionality, and purpose. The connector system of FIGS. 42-47 facilitates electrical coupling between multiple connectors 200a, 200b, enabling the dynamic expansion or contraction of connection ports 222 without replacing the entire assembly. The connector system includes connectors 200 with housings 220 that define conductor ports 222 for receiving electrical conductors 242, busbars 224 positioned within the housings 220 to electrically couple the electrical conductors 242, and extension tabs 226 accessible through housing ports 228, 230 to establish electrical contact between interconnected connectors 200a, 200b. The connector system also supports various connection arrangements, such as unidirectional or bidirectional conductor orientations, and enables coupling while under load.

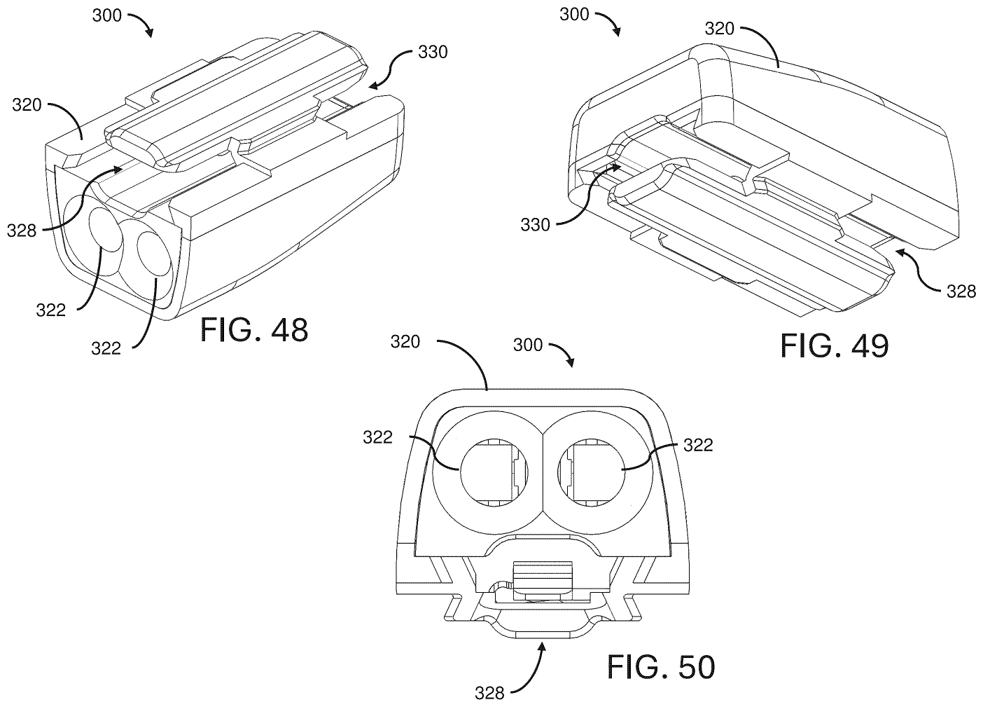

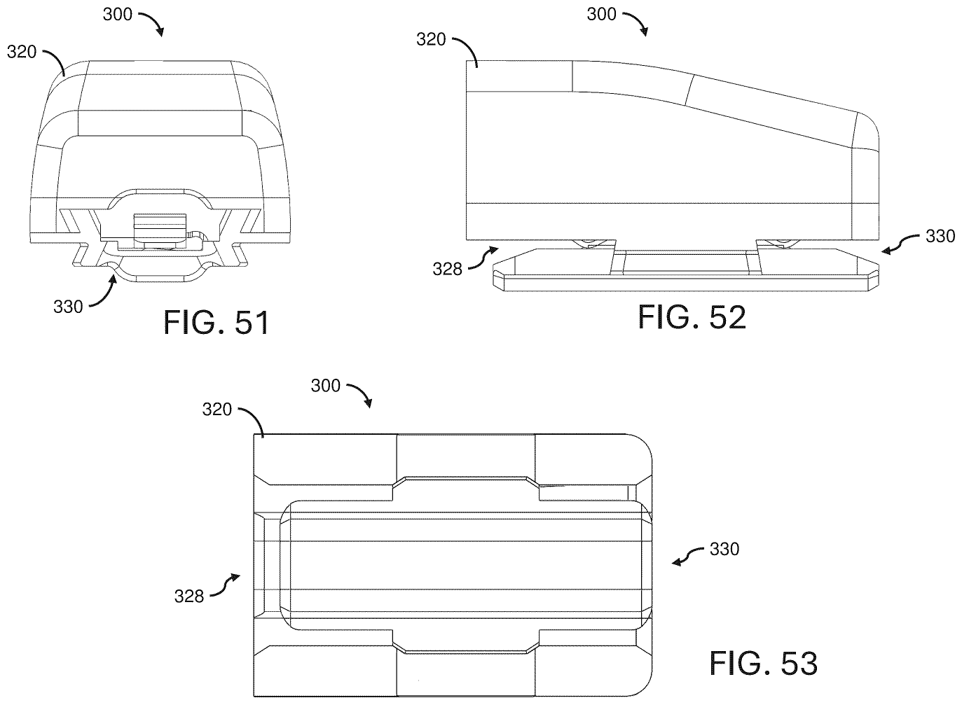

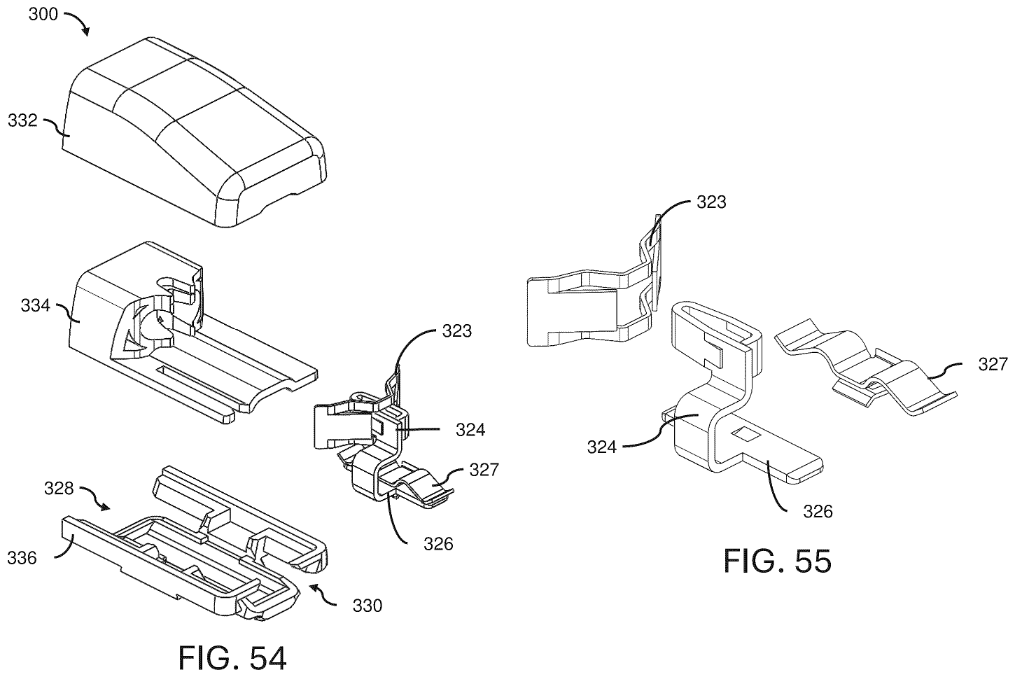

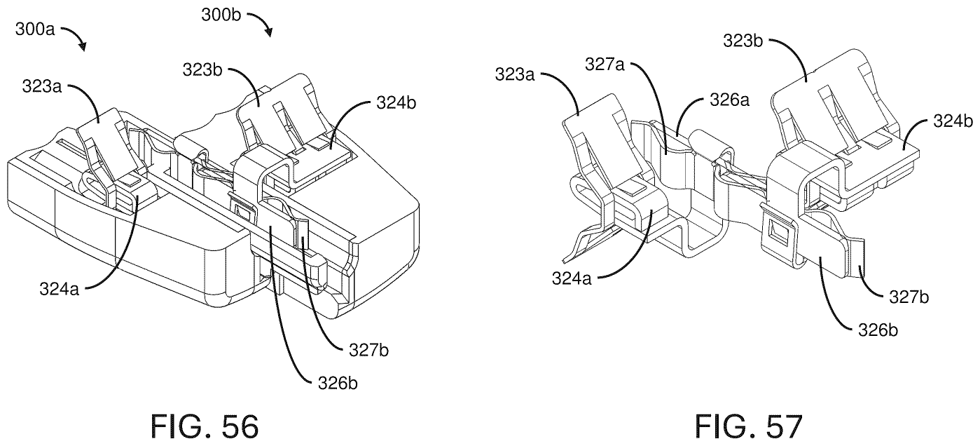

FIGS. 48-55 are various views of an example in-line splicing connector 300. For purposes of explanation, the connector 300 refers to the example splicing connector generally, while a particular implementation of the example connector in a 2-port configuration is referred to as a connector 300a (e.g., shown in FIG. 56) and the example connector in a 4-port configuration is referred to as a connector 300b (e.g., shown in FIG. 56). It should be understood that the connector 300 is not limited to 2- and 4-port implementations and can include any number of ports.

The splicing connector 300 is similar to the splicing connector 100 in terms of its overall structure, functionality, and purpose. The connector 300 includes a housing 320 that defines multiple conductor ports 322 for receiving electrical conductors 342, a busbar 324 positioned within the housing 320 to electrically couple the electrical conductors 342, and extension tabs 326 accessible through housing ports 328, 330 to facilitate electrical contact with other connectors inserted therein. The housing 320 may include an upper case 332, lower case 336, and/or cap 334 within the upper case 332 and lower case 336 and defining the conductor ports 322.

The busbar 324 may include or be electrically coupled to one or more extension tabs 326. A conductor connection mechanism 323 (e.g., conductor connection mechanism 323a, 323b) may include a spring or other biasing mechanism for holding an electrical conductor 342 against the busbar 324. An extension tab connection mechanism 327 (e.g., extension tab connection mechanism 327a, 327b) may include a spring or other biasing mechanism for holding a secondary extension tab from another connector against an extension tab 326.

A distinction between the splicing connector 300 and the splicing connector 100 includes placement of the housing ports 328, 330. In the splicing connector 100, the housing ports 128, 130 are positioned on opposite sides of the housing 120, enabling connections to be made in multiple spatial configurations, such as “side-to-side.” The splicing connector 300 includes housing ports 328, 330 located on the bottom side of the housing 320, consolidating the connection points to a single side. This design allows for a more streamlined coupling arrangement, where connectors are joined vertically or stacked in a “bottom-to-bottom” configuration. As shown in the figures, the housing ports 328, 330 are parallel with the conductor ports 322. Despite this difference, the splicing connector 300 retains the modular and touch-safe features of the splicing connector 100, enabling it to be used individually or as part of an interconnected assembly of connectors (e.g., a connector system).

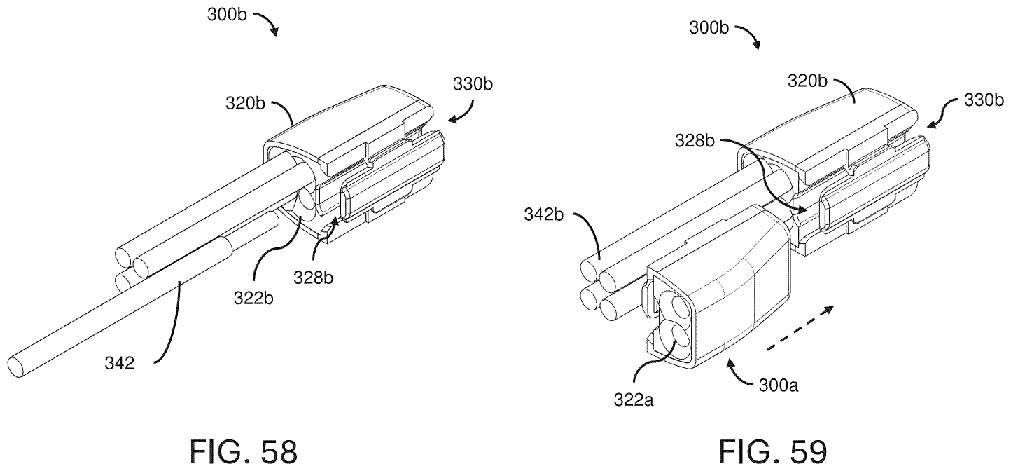

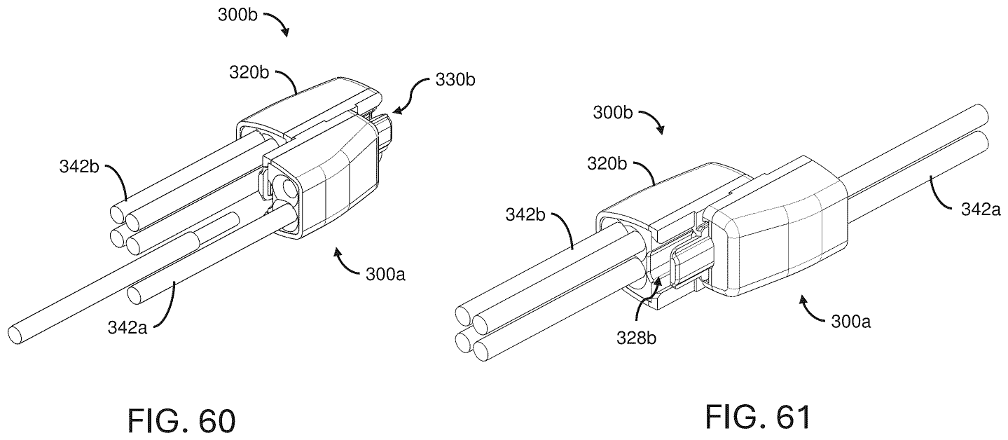

The connector system that utilizes splicing connectors 300, as shown in FIGS. 56-61, is similar to the connector system that utilizes splicing connectors 100, shown in FIGS. 10-15, in terms of its overall structure, functionality, and purpose. The connector system of FIGS. 56-61 facilitates electrical coupling between multiple connectors 342, enabling dynamic expansion or contraction of the number of connection ports 322 without replacing the entire assembly. The connector system includes connectors 300a, 300b with housings 320a, 320b that define conductor ports 322a, 322b for receiving electrical conductors 342a, 342b, busbars 324a, 324b positioned within the housings 320a, 320b to electrically couple the electrical conductors 342a, 342b, and extension tabs 326a, 326b accessible through housing ports 328a, 328b, 330a, 330b to establish electrical contact between interconnected connectors 300a, 300b. The connector system supports flexible conductor orientations, such as unidirectional or bidirectional configurations, and enable coupling while under load.

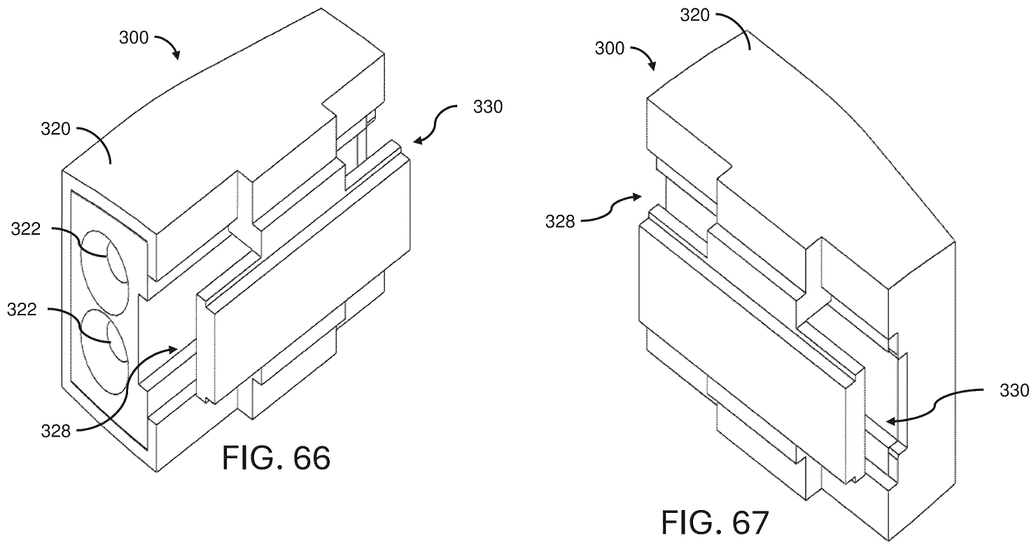

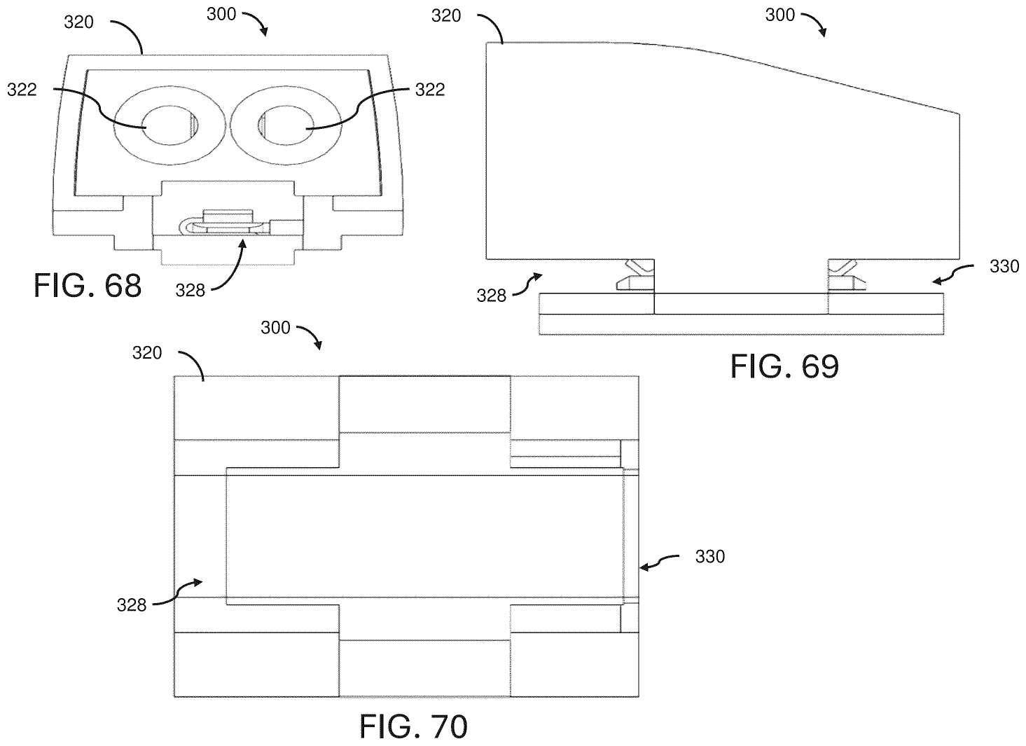

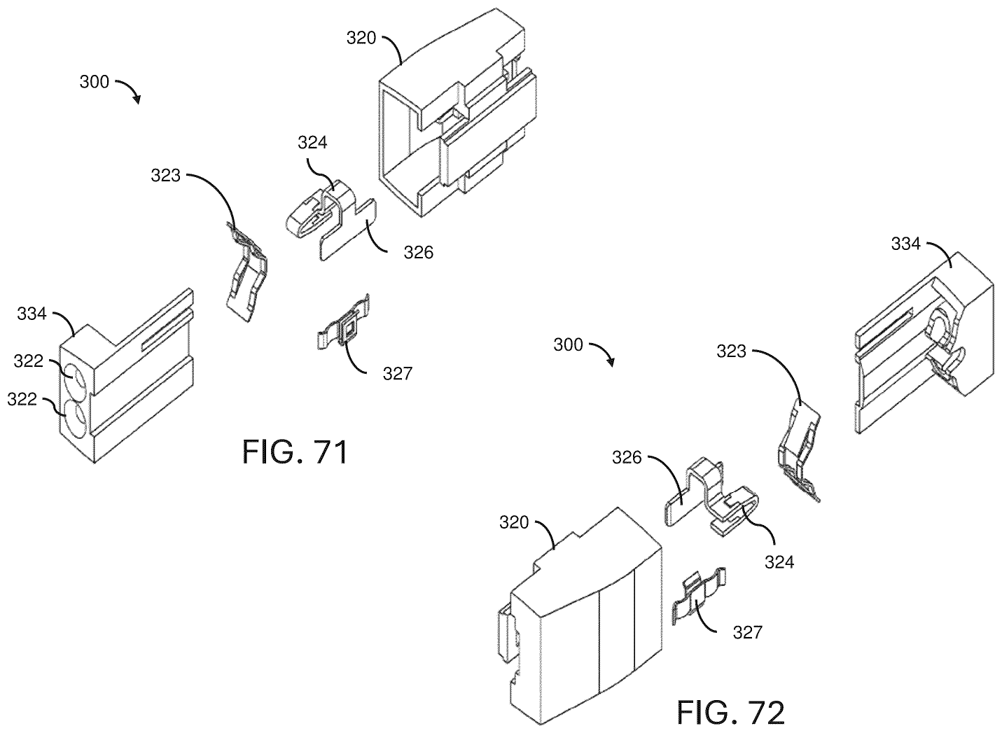

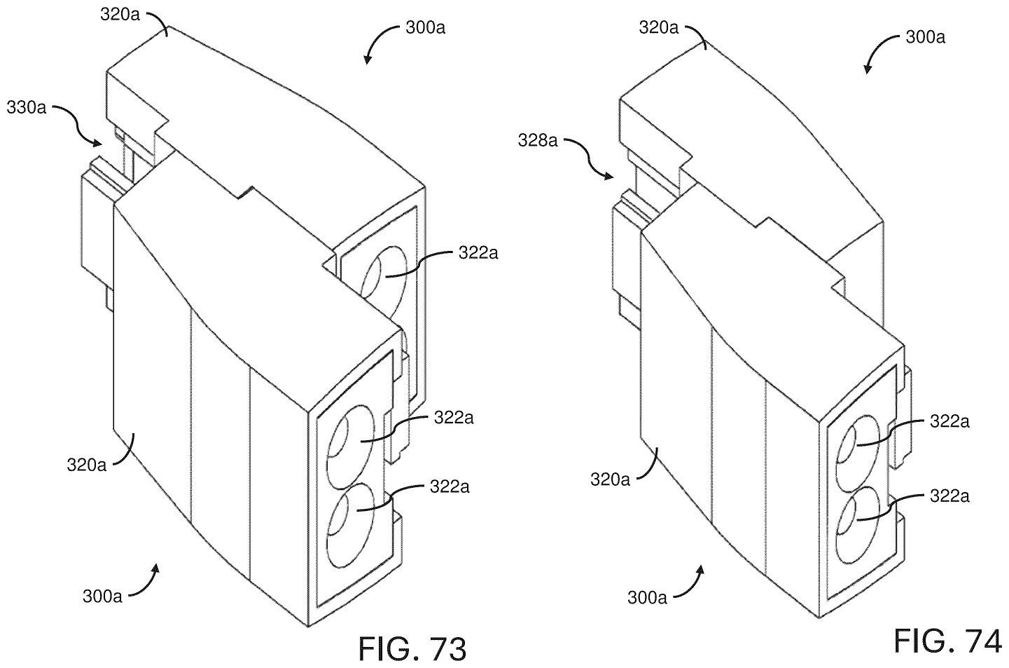

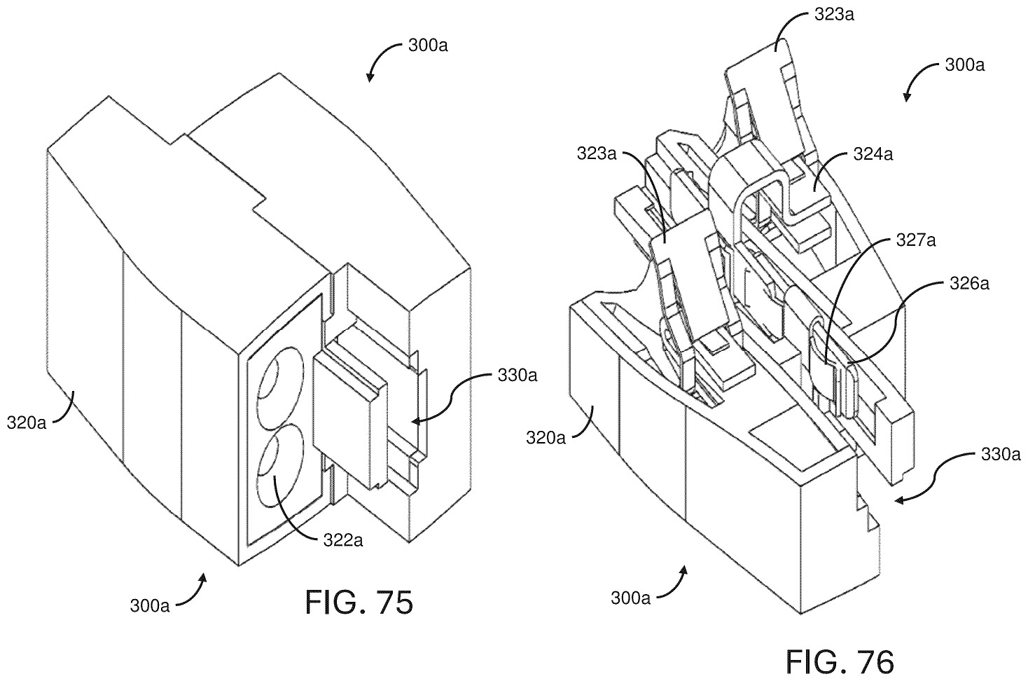

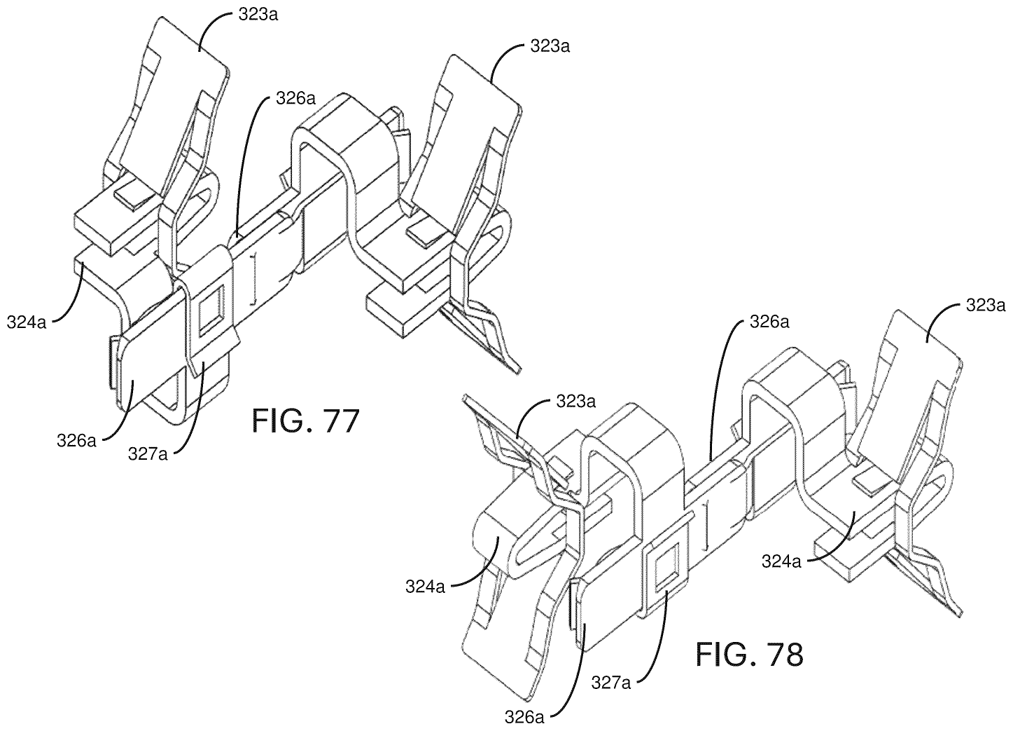

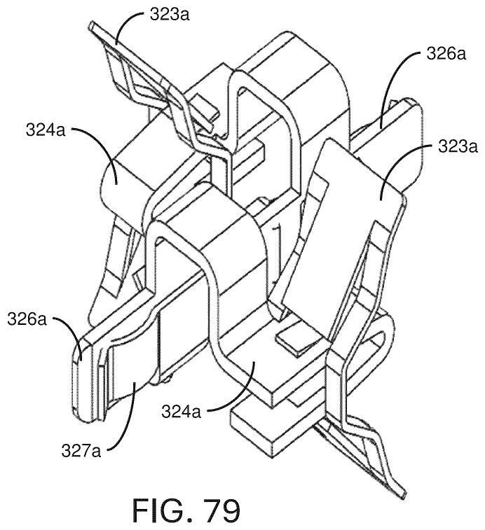

FIGS. 66-72 depict another embodiment of the example connector 300 and FIGS. 73-79 depict another embodiment of the example connector system. The construction of this embodiment of the example connector 300 and connector system are similar to the disclosed examples, and the components are similarly arranged with various configuration differences.

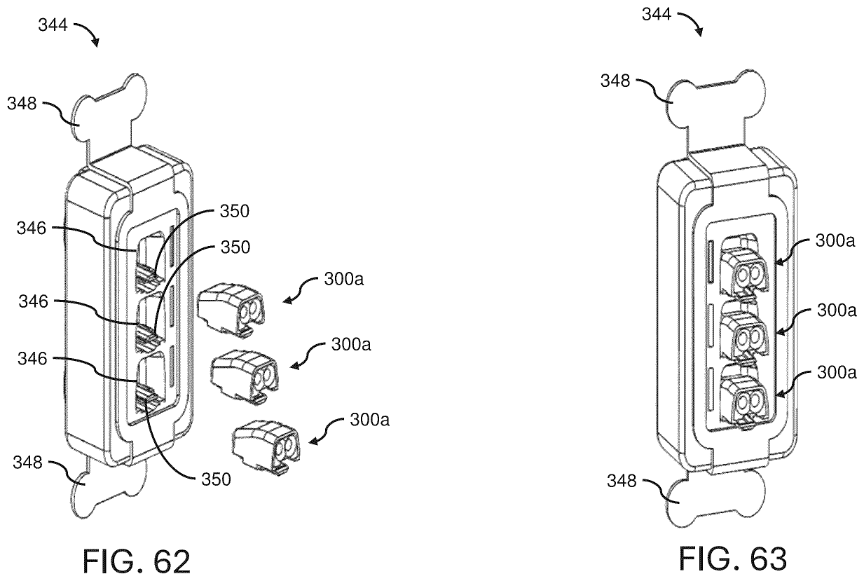

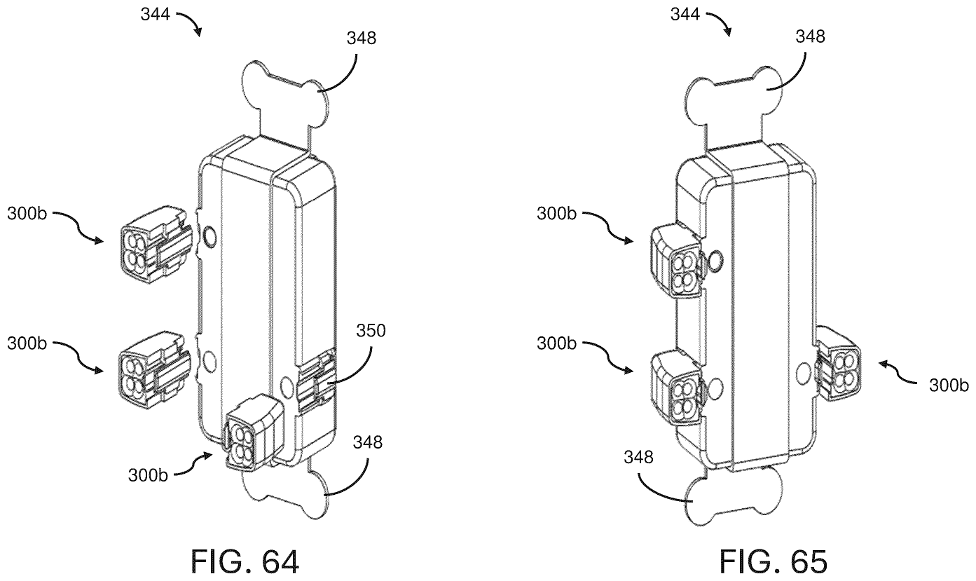

FIGS. 62-65 depict an example hub 344 for connectors 300. The connector hub 344 is similar to the connector hub 144 but is adapted for use with the splicing connector 300. While the connector hub 144 includes housing ports 150 that interface with connectors having housing ports on opposite sides, such as the splicing connector 100, the connector hub 344 includes housing ports 350 (e.g., in connector ports 346) aligning with the bottom-side housing ports 328 or 330 of the splicing connector 300. Like the connector hub 144, the connector hub 344 includes internal conductive elements, such as busbars and extension tabs, that establish electrical contact between the connectors 300 connected to the housing ports 350. In some embodiments, a hub may be an outlet, switch, dimmer, light fixture, or any other suitable device.

The hub 344 may include one or more terminals 348 (e.g., on its ends), enabling the hub 344 to interface with external systems or devices. In some embodiments, the terminals 148 may be used for mounting purposes in addition to or instead of electrical connectivity purposes.

The connector hubs 344 can be adapted for use with various example connectors by modifying its housing ports 350 and/or connector ports 346 to accommodate the specific design and spatial configuration of the connectors.

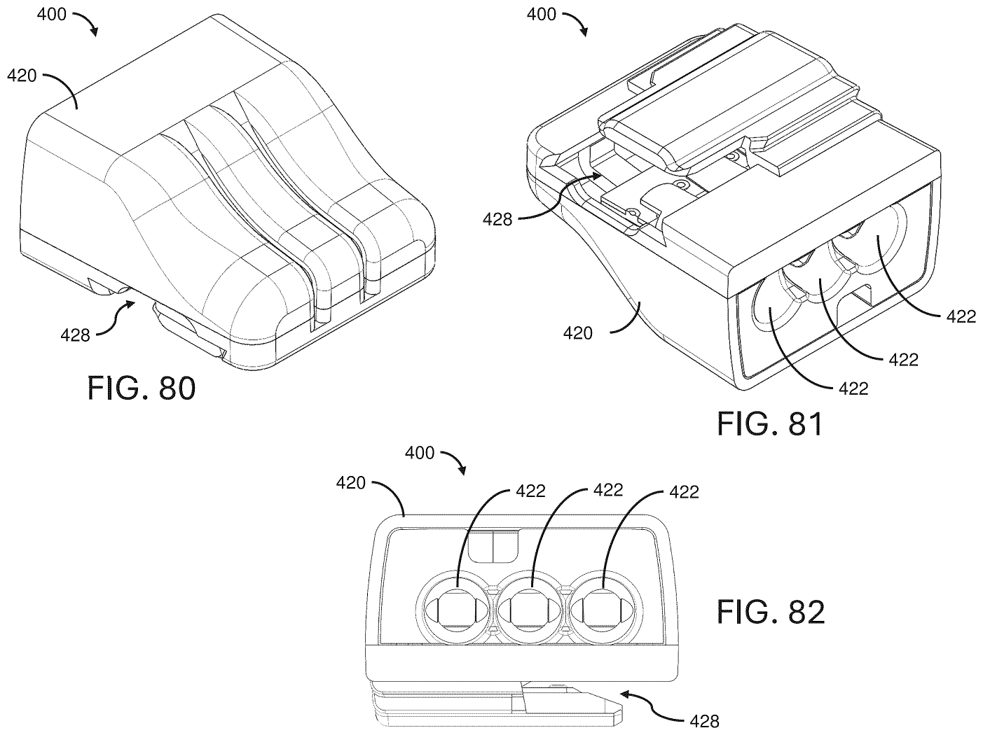

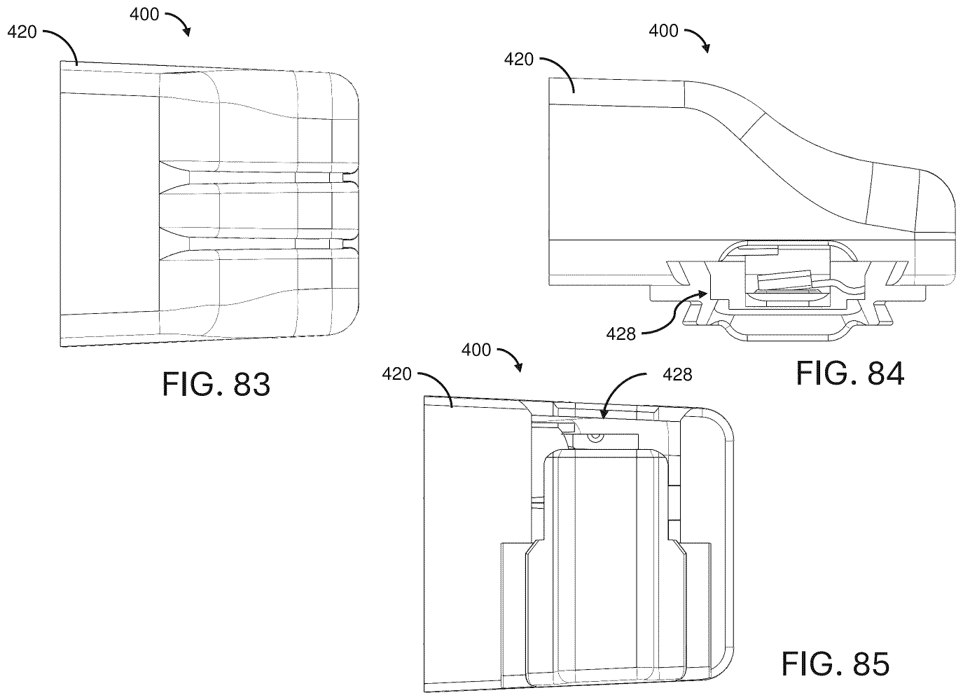

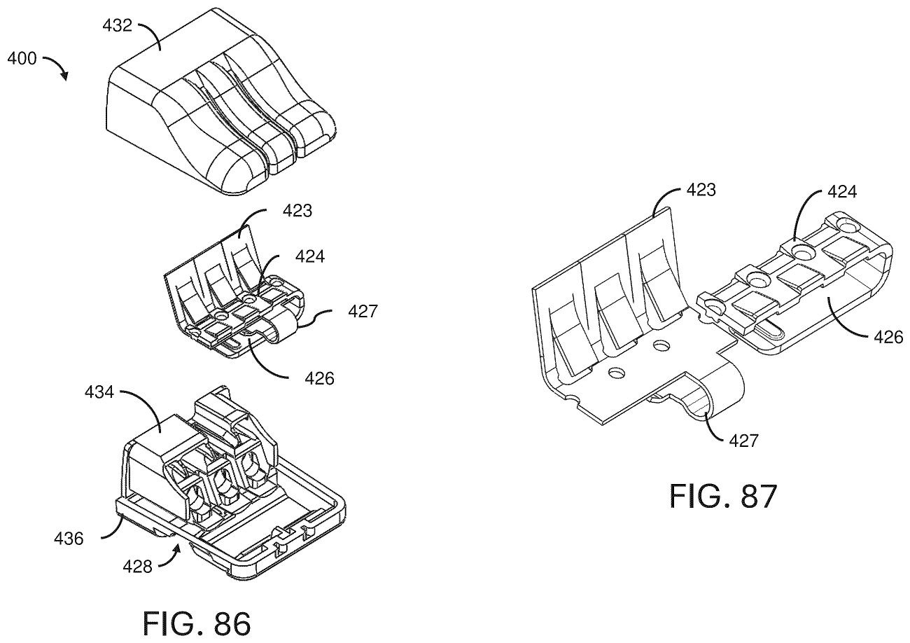

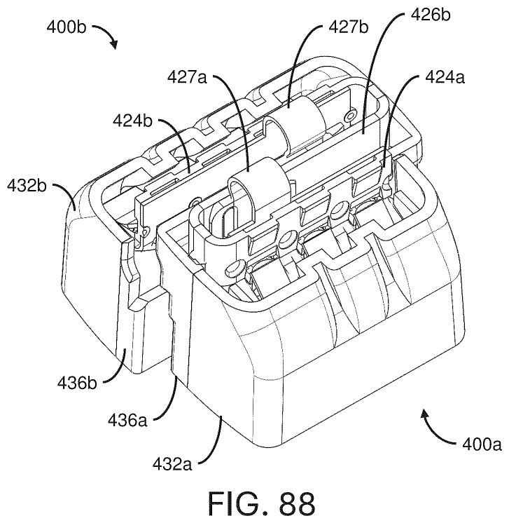

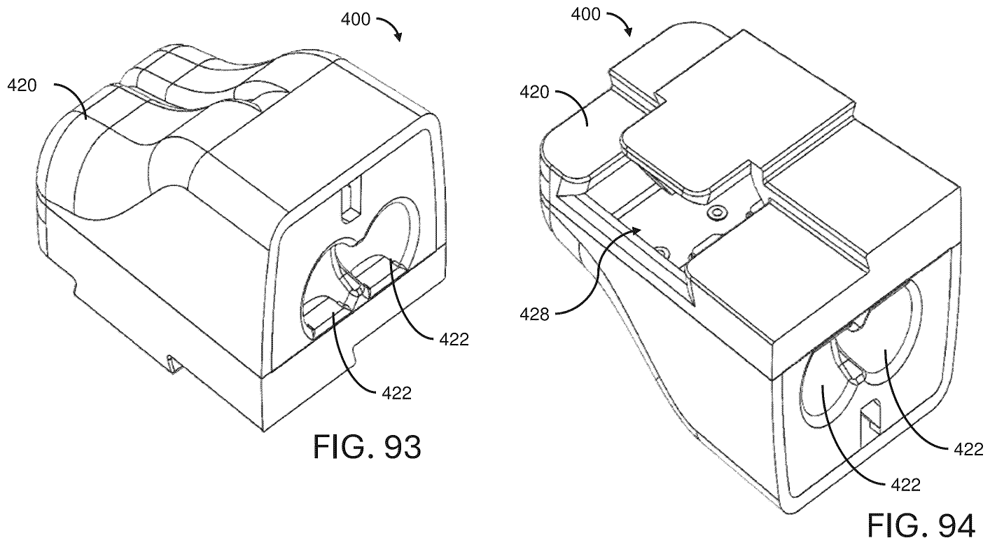

FIGS. 80-87 are various views of an example in-line splicing connector 400. For purposes of explanation, the connector 400 refers to the example splicing connector generally, while a particular implementation of the example connector in a 3-port configuration is referred to as a connector 400a (e.g., shown in FIG. 88), the example connector in a 4-port configuration is referred to as a connector 400b (e.g., shown in FIG. 88), and the example connector in a 2-port configuration is referred to as a connector 400c (e.g., shown in FIG. 93). It should be understood that the connector 300 is not limited to 2- and 4-port implementations and can include any number of ports.

The splicing connector 400 is similar to the splicing connector 100 in terms of its overall structure, functionality, and purpose. The connector 400 includes a housing 420 (e.g., housing 420a, 420b, 420c) that defines multiple conductor ports 422 (e.g., conductor ports 422a, 422b, 422c) for receiving electrical conductors 442 (e.g., electrical conductors 442a, 442b), a busbar 424 (e.g., busbar 424a, 424b, 424c) positioned within the housing 420 to electrically couple the electrical conductors 442, and extension tabs 426 (e.g., extension tabs 426b, 426c) accessible through housing port 428 to facilitate electrical contact with other connectors inserted therein. The housing 420 may include an upper case 432 (e.g., upper case 432a, 432b), lower case 436 (e.g., lower case 436a, 436b), and/or cap 434 within the upper case 432 and lower case 436 and defining the conductor ports 422.

The busbar 424 may include or be electrically coupled to one or more extension tabs 426. A conductor connection mechanism 423 (e.g., conductor connection mechanism 423a, 423c) may include a spring or other biasing mechanism for holding an electrical conductor 442 against the busbar 424. An extension tab connection mechanism 427 (e.g., extension tab connection mechanism 427a, 427b, 427c) may include a spring or other biasing mechanism for holding a secondary extension tab from another connector against an extension tab 426.

A distinction between the splicing connector 400 and the splicing connector 100 includes the placement and orientation of the housing ports. In the splicing connector 100, the housing ports 128, 130 are positioned on the left and right sides of the housing 120 and are parallel to the conductor ports 122, allowing for versatile spatial configurations, such as “side-to-side” arrangements. The splicing connector 400 includes housing port 428 (e.g., housing port 428a) located on the bottom side of the housing 420, consolidating the connection points to a single side, and the housing port 428 are oriented perpendicular to the conductor ports. This perpendicular arrangement enables connectors to be joined laterally in a “bottom-to-bottom” configuration while maintaining a distinct spatial relationship between the conductor ports 422 and housing port 428. The splicing connector 400 retains the modular and touch-safe features of the splicing connector 100, enabling the connector 400 to be used individually or as part of an interconnected assembly of connectors (e.g., a connector system).

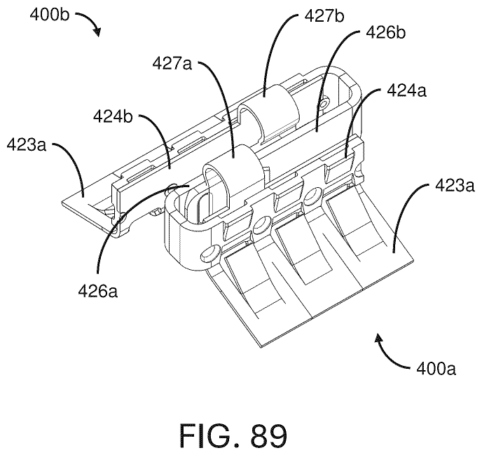

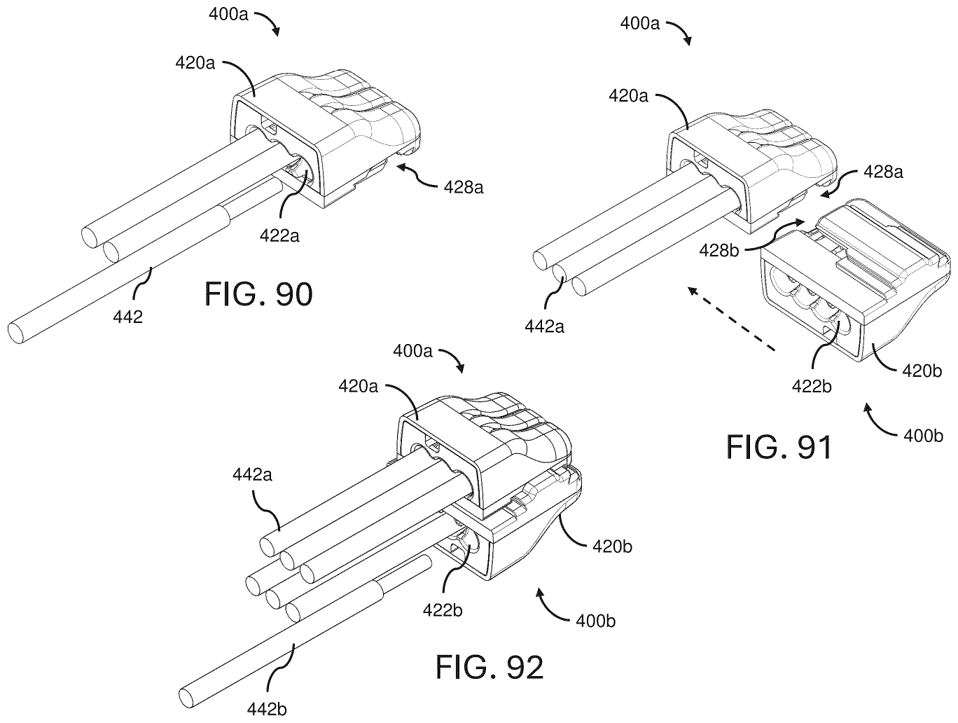

The connector system that utilizes splicing connectors 400, as shown in FIGS. 88-92, is similar to the connector system that utilizes splicing connectors 100, shown in FIGS. 10-15, in terms of its overall structure, functionality, and purpose. The connector system of FIGS. 88-92 facilitates electrical coupling between multiple connectors 442, enabling dynamic expansion or contraction of the number of connection ports 422 without replacing the entire assembly. The connector system includes connectors 400a, 400b with housings 420a, 420b that define conductor ports 422a, 422b for receiving electrical conductors 442a, 442b, busbars 424a, 424b positioned within the housings 420a, 420b to electrically couple the electrical conductors 442a, 442b, and extension tabs 426a, 426b accessible through housing ports 428a, 428b to establish electrical contact between interconnected connectors 400a, 400b. The connector system supports flexible conductor orientations, such as unidirectional or bidirectional configurations, and enable coupling while under load.

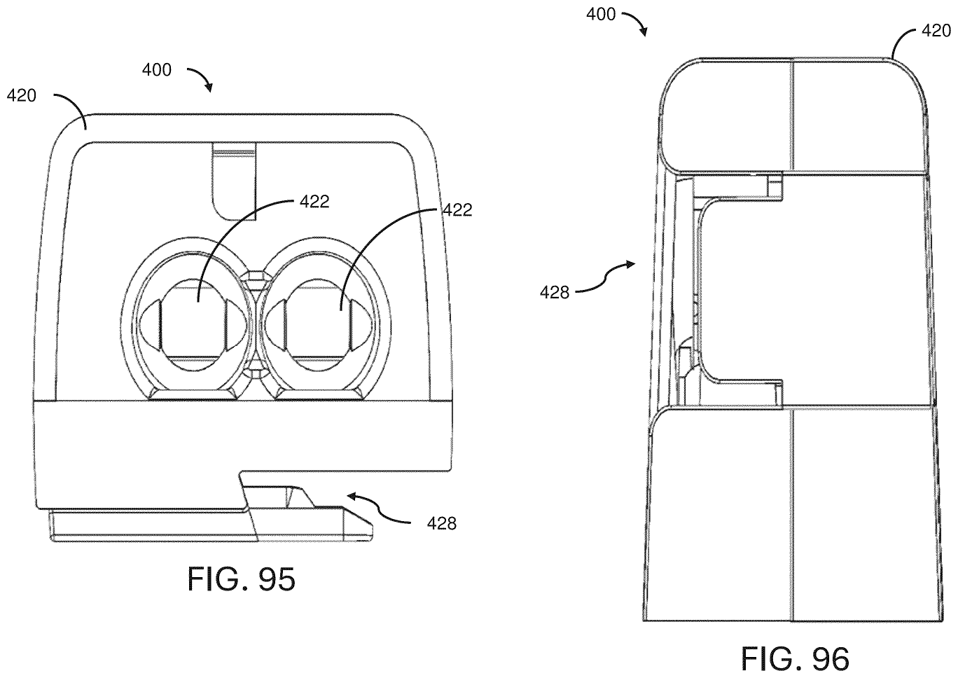

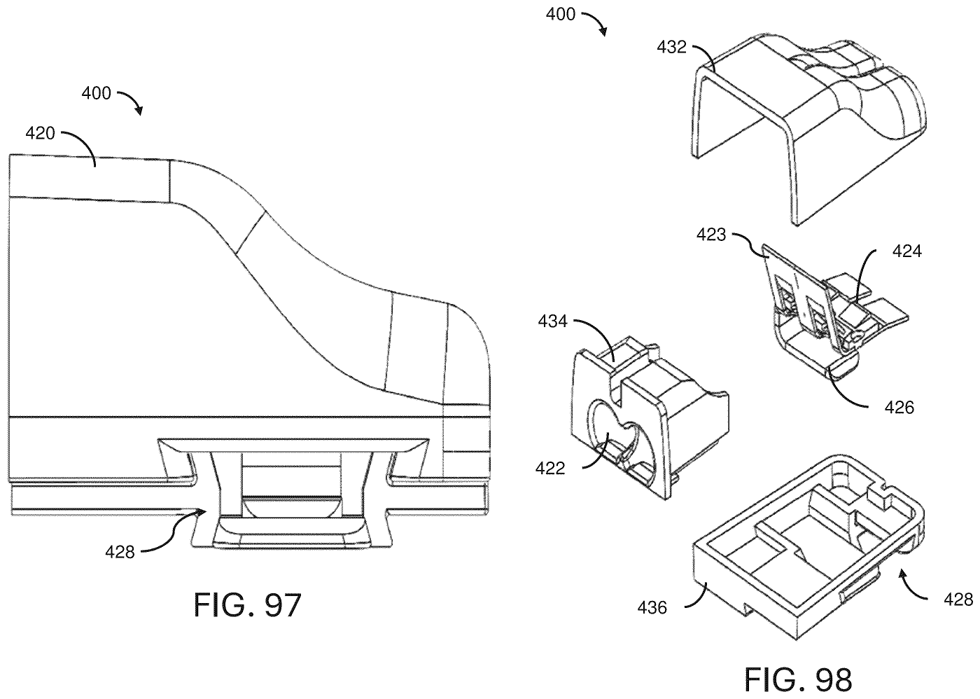

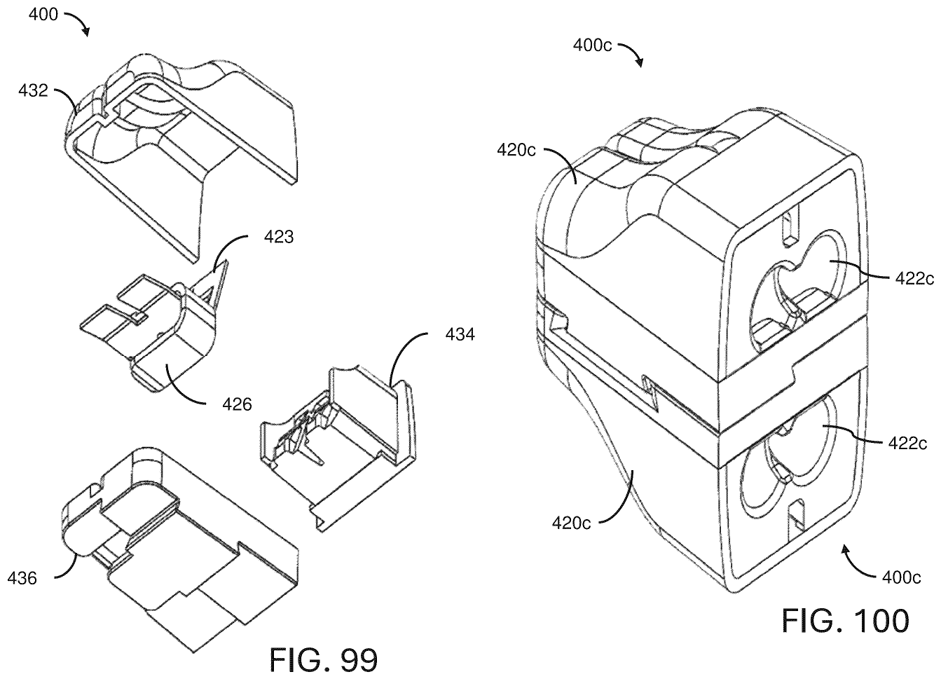

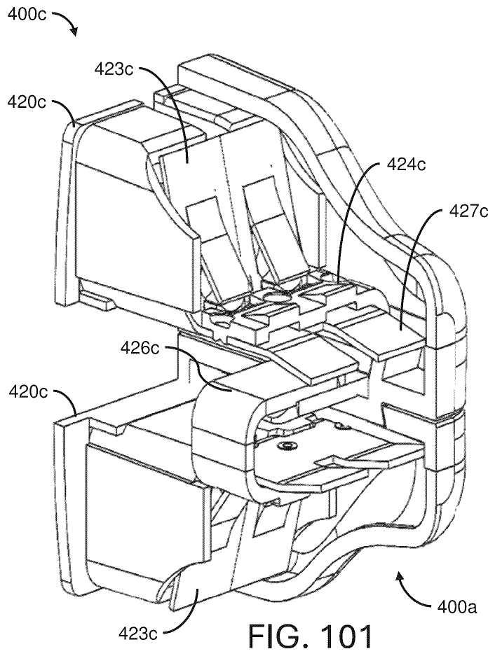

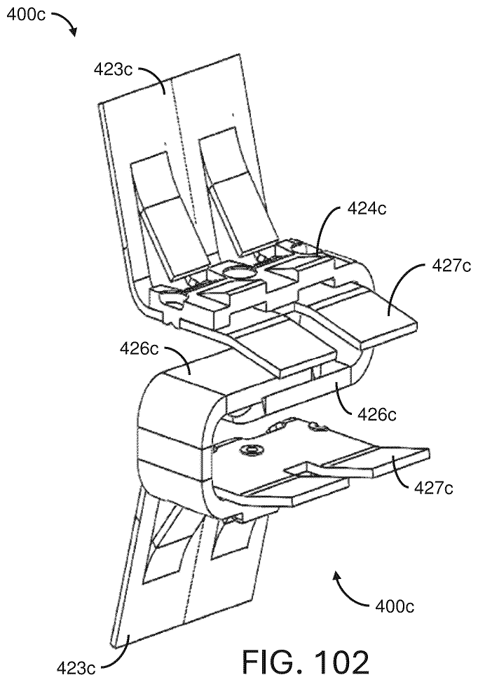

FIGS. 93-99 depict another embodiment of the example connector 400 and FIGS. 100-102 depict another embodiment of the example connector system. The construction of this embodiment of the example connector 400 and connector system are similar to the disclosed example, and the components are similarly arranged with various configuration differences.

While this disclosure has described certain embodiments, it will be understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known components have not been described in detail so as not to unnecessarily obscure various aspects of the present disclosure.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An electrical connector comprising:
a housing defining one or more conductor ports and a housing port, wherein each conductor port of the one or more conductor ports is associated with a respective clamping connection for retaining one or more electrical conductors;
a busbar positioned within the housing and electrically coupling the one or more electrical conductors in electrical contact with the busbar; and
an extension tab positioned within the housing, accessible through the housing port, and electrically coupled to the busbar for facilitating electrical contact with a secondary busbar of another electrical connector.

2. An electrical connector system comprising:
a first electrical connector of to claim 1; and
a second electrical connector, the second electrical connector comprising:
a secondary housing defining one or more secondary conductor ports and a secondary housing port, wherein each secondary conductor port of the one or more secondary conductor ports is associated with a respective clamping connection for retaining one or more secondary electrical conductors;
the secondary busbar positioned within the secondary housing and electrically coupling the one or more secondary electrical conductors in electrical contact with the secondary busbar; and
a secondary extension tab positioned within the secondary housing, accessible through the secondary housing port, and electrically coupled to the secondary busbar for facilitating electrical contact with the busbar when the secondary extension tab is inserted into the housing port of the first electrical connector and the extension tab of the first electrical connector is inserted into the secondary housing port of the second electrical connector.

3. The electrical connector system of claim 2, wherein the first electrical connector is structurally identical to the second electrical connector.

4. The electrical connector system of claim 2, wherein the one or more conductor ports receive the one or more electrical conductors in a same direction that the one or more secondary conductor ports receive the one or more secondary electrical conductors.

5. The electrical connector of claim 2, wherein the one or more conductor ports receive the one or more electrical conductors in an opposite direction that the one or more secondary conductor ports receive the one or more secondary electrical conductors.

6. The electrical connector of claim 1, wherein the extension tab is a first extension tab and the housing port is a first housing port, the electrical connector further comprising:
a second housing port; and
a second extension tab positioned within the housing, accessible through the second housing port, and electrically coupled to the busbar for facilitating electrical contact with a secondary busbar of another electrical connector;
whereby the electrical connector is electrically couplable with additional electrical connectors via the first extension tab and the second extension tab.

7. The electrical connector of claim 1, wherein the housing comprises:
an upper case;
a lower case, wherein one or more of the upper case and the lower case define the housing port; and
a cap positioned between the upper case and the lower case, wherein the cap defines the one or more conductor ports.

8. The electrical connector of claim 1, wherein the extension tab extends into the housing port.

9. The electrical connector of claim 1, wherein the extension tab is monolithic with the busbar.

10. The electrical connector of claim 1, wherein the housing port is associated with a friction-based connection, the respective clamping connection is associated with a respective first biasing mechanism, and the friction-based connection is associated with a second biasing mechanism.

11. The electrical connector of claim 10, wherein the first biasing mechanism and the second biasing mechanism are monolithic with each other.

12. The electrical connector of claim 10, wherein the second biasing mechanism is engageably connected to the extension tab.

13. The electrical connector of claim 1, wherein the one or more conductor ports are parallel with the housing port.

14. The electrical connector of claim 1, wherein the one or more conductor ports are perpendicular with the housing port.

15. The electrical connector of claim 1, wherein the busbar is parallel with the extension tab.

16. The electrical connector of claim 1, wherein the busbar is perpendicular with the extension tab.

17. An electrical connector comprising:
a housing defining a housing port associated with a first connection type for retaining a secondary busbar of another electrical connector;
a cap positioned within the housing and defining one or more conductor ports, wherein each conductor port of the one or more conductor ports is associated with a second connection type for retaining one or more electrical conductors;
a busbar positioned within the housing, supported by the cap, and electrically coupling the one or more electrical conductors in electrical contact with the busbar; and
an extension tab positioned within the housing, accessible through the housing port, and electrically coupled to the busbar for facilitating electrical contact with the secondary busbar.

18. An electrical connector system comprising:
a first electrical connector of to claim 17; and
a second electrical connector, the second electrical connector comprising:
a secondary housing defining a secondary housing port associated with the first connection type for retaining the busbar of the first electrical connector;
a secondary cap positioned within the secondary housing and defining one or more secondary conductor ports, wherein each secondary conductor port of the one or more secondary conductor ports is associated with the second connection type for retaining one or more secondary electrical conductors;
the secondary busbar positioned within the secondary housing, supported by the secondary cap, and electrically coupling the one or more secondary electrical conductors in electrical contact with the secondary busbar; and
a secondary extension tab positioned within the secondary housing, accessible through the secondary housing port, and electrically coupled to the secondary busbar for facilitating electrical contact with the busbar when the secondary extension tab is inserted into the housing port of the first electrical connector and the extension tab of the first electrical connector is inserted into the secondary housing port of the second electrical connector.

19. The electrical connector of claim 18, wherein the electrical connector is structurally identical to the second electrical connector.

20. The electrical connector of claim 17, wherein the extension tab extends into the housing port and the extension tab is monolithic with the busbar.
